(19) United States
(12) Patent Application Publication
(10) Pub. No.: US 2005/0148488 A1
(43) Pub. Date: Jul. 7, 2005

(54) Detergent tablets with active phase

(76) Inventors: Maren Jekel, Barcelona (ES); Michael Dreja, Koeln (DE); Andreas Buhl, Langenfeld (DE); Arnd Kessler, Monheim (DE)

Correspondence Address: HENKEL CORPORATION, THE TRIAD, SUITE 200, 2200 RENAISSANCE BLVD., GULPH MILLS, PA, 19406, US

(21) Appl. No.: 10/989,230

(22) Filed: Nov. 15, 2004

Related U.S. Application Data
(63) Continuation of application No. PCT/EP03/04712, filed on May 6, 2003.

(30) Foreign Application Priority Data
May 15, 2002 (DE) 102 21 559.6

(51) Int. Cl. C11D 17/00

(52) U.S. Cl. 510/447

(57) ABSTRACT

A single- or multiphase detergent tablet that has at least one active phase containing one or more washing or cleaning substance(s), a solid matrix enclosing the substance(s) in the form of a solidified melt, wherein the matrix material is selected from sugars, sugar acids, sugar alcohols, and any mixtures thereof, and wherein the solid matrix has a solubility above 100 g/l at 20° C. and the proportion by weight of the solid matrix in the total weight of the active phase is at least 10% by weight.

### CROSS REFERENCE TO RELATED APPLICATIONS

This application is a continuation under 35 U.S.C. § 365(c) and 35 U.S.C. § 120 of international application PCT/EP02/07138, filed on May 6, 2003. This application also claims priority under 35 U.S.C. § 119 of DE 102 21 559.6, filed May 15, 2002, which is incorporated herein by reference in its entirety.

### BACKGROUND OF THE INVENTION

The present invention lies in the field of detergent tablets, as are used, for example, for the portioning and metering of all-purpose detergents for textiles or machine dishwasher detergents. In particular, the present invention relates to single- or multiphase detergent tablets which have an active phase which in turn enables the accelerated release of washing and cleaning substances, especially care additives, and associates this improved performance profile with improved product appearance.

In the detergents sector, detergent tablets are enjoying high acceptance by the consumer owing to their ease of handling. In the effort to achieve continuing improvement in these products, combination products have been developed in recent times and have not only the classical cleaning action but also, for example, an additional fabric softener or rinse aid function. The integration of one or more additional function(s) into the conventional detergents makes separate metering of an appropriate second product (fabric softener, rinse aid, etc.) in an additional operation superfluous, and the entire procedure is simplified. However, a prerequisite for the optimal effectiveness of the integrated additional function included in the detergent is the time-controlled release of this additive. The prior art products for the incorporation and controlled release of detergent additives are generally technically complex and have frequently been developed for the use of specific additives and are thus not universally usable.

For instance, WO 00/51724 (Procter & Gamble Company) describes the use of molecular sieves having a pore diameter above 8 angstrom for the incorporation and the controlled release of additives of textile detergents such as fabric softeners or fragrances. However, the use of the disclosed molecular sieves is technically comparatively complex. The insoluble molecular sieves can additionally remain after use as insoluble residues on the objects to be cleaned.

WO 00/39259 and WO 01/64823 (Reckitt Benckiser) disclose water-soluble glasses and ceramic compositions for the corrosion protection of glassware. The water-soluble glass or the ceramic contain at least one active agent for the corrosion protection of glassware (e.g. Zn oxides, Al oxides, Ti oxides) and are used in solid, particulate form in machine dishwashing. The glasses and ceramics described are suitable only for glass corrosion protection. Additives for silver corrosion protection or film inhibition cannot be integrated into the claimed glasses.

It is therefore an object of the present application to provide a detergent tablet which is suitable for the incorporation of the abovementioned combination products and simultaneously enables rapid release of additives present in these combination products, especially of additives having a low proportion by weight in the overall formulation of the detergent tablets, without being restricted to selected additives. Simultaneously, the corresponding detergent tablet should have an improved appearance, and it should in particular be possible to realize direct visualization of the additives present in the combination product.

This object is achieved by the provision of single- or multiphase detergent tablets which have at least one active phase. The present application therefore firstly provides a single- or multiphase detergent tablet which has at least one active phase which consists of one or more washing and/or cleaning substance(s) and a solid matrix enclosing this/these substance(s), characterized in that the solid matrix has a solubility above 100 g/l at 20° C. and the proportion by weight of the solid matrix in the total weight of the active phase is at least 10% by weight.

The active phase(s) present in the inventive tablets accordingly serve for the incorporation of washing and/or cleaning substances, preferably selected additives from the detergents sector. The matrix structure of the active phase, based on at least 10% by weight of matrix material, combined with the high solubility of this matrix material, improves the release profile of the enclosed washing and/or cleaning substances and results in an optimized action of these substances.

Even though the use of matrix materials having a solubility above 100 g/l has been found to be suitable in the context of the present application for the achievement of the object of the invention, the advantageous action of inventive products is enhanced even further by the use of matrix materials having solubilities above 200 g/l. The present application therefore preferably further provides detergent tablets as claimed in claim 1, characterized in that the solid matrix/matrices has/have a solubility above 200 g/l at 20° C., preferably above 300 g/l at 20° C. When the solid matrices are formed from more than one matrix material, all matrix materials used in the context of the present invention have a solubility above 100 g/l at 20° C., preferably above 200 g/l at 20° C., in particular above 300 g/l at 20° C.

A matrix structure in the context of the present application can be realized in various ways. In a first preferred embodiment, the matrix is a homogeneous, solid phase in which the washing and/or cleaning substance(s) is/are present in homogeneous distribution. Such a homogeneous distribution may be achieved, for example, by dissolving all washing and/or cleaning substances present in the active phase in a solution or melt of the matrix material and subsequently solidifying this solution or melt. However, the washing and cleaning substances may also be present in the inventive matrix in heterogeneous distribution. Such heterogeneous distributions may arise, for example, when solid particles of the washing and/or cleaning substance(s) is/are mixed with or poured over with a solution or melt of the matrix material without dissolving. Settling motions, for example owing to different densities of the substances used, may then lead in the course of solidification to nonuniform distribution of the solid particles within the matrix.

As can be taken from the above information, the incorporation of washing and/or cleaning additives with the aid of a melt of the matrix material is a preferred procedure in the context of the present application. In a further preferred embodiment of the inventive detergent tablets, the matrix material used is therefore one or more meltable substance(s) which has/have a melting point between 30 and 250° C., preferably between 35 and 200° C. and in particular between 40 and 180° C. Particular preference is given in the context of the present application to active phases in which all matrix materials have a melting point between 30 and 250° C., preferably between 35 and 200° C. and in particular between 40 and 180° C.

Some examples of matrix materials which are suitable in the context of the present invention and have a solubility of above 100 g/l, which have the criterion of a melting point between 30 and 250° C. are combined in the following table:

| | Melting | |
|---|---|---|
| | point | Solubility |
| | [° C.] | [g/l H₂O] |
| Ammonium aluminum sulfate dodecahydrate | 93 | 150 |
| Potassium aluminum sulfate dodecahydrate | 92 | 110 |
| Aluminum sulfate monohydrate | 90 | 600 |
| Aluminum sulfate octadecahydrate | 90 | 600 |
| Sodium phosphinate monohydrate | 90 | 1000 |
| Sodium dihydrogenphosphate | 100 | 1103 |
| Sodium dihydrogenphosphate monohydrate | 100 | 1103 |
| Sodium ammonium hydrogenphosphate tetrahydrate | 79 | 167 |
| Disodium hydrogenphosphate heptahydrate | 48 | 154 |
| Trisodium phosphate dodecahydrate | 75 | 258 |
| Tripotassium phosphate heptahydrate | 46 | 900 |
| Ammonium iron(II) sulfate hexahydrate | 100 | 269 |
| Iron sulfate heptahydrate | 64 | 400 |
| Glucose | 83 | 820 |
| Magnesium acetate tetrahydrate | 80 | 1200 |
| Manganese(II) chloride tetrahydrate | 58 | 1980 |
| Sodium acetate trihydrate | 58 | 762 |
| Sodium hydrogensulfate monohydrate | 58 | 670 |
| Sodium carbonate peroxidohydrate | 60 | 150 |
| Sodium thiosulfate pentahydrate | 48 | 680 |
| Potassium sodium tartrate tetrahydrate | 70-80 | 630 |
| D-(+)-glucose monohydrate | 83 | 820 |
| Zinc acetate dihydrate | 100 | 430 |
| Zinc sulfate heptahydrate | 40 | 960 |

In the context of the present invention, particularly suitable matrix materials have been found to be the sugars, sugar acids and sugar alcohols. These substances are generally not only sufficiently soluble but also additionally feature low costs and good processibility. For instance, sugars and sugar derivatives, especially the mono- and disaccharides and derivatives thereof, can be processed, for example, in the form of their melts, these melts having good dissolution capability both for dyes and for many washing and cleaning substances. The solid bodies resulting from the solidification of the sugar melts additionally feature a smooth surface and advantageous appearance, such as high surface brightness or transparent appearance.

Preferred detergent tablets in the context of the present invention are accordingly characterized in that the matrix material is selected from the group of the sugars and/or sugar acids and/or sugar alcohols, preferably from the group of the sugars, more preferably from the group of the oligosaccharides, oligosaccharide derivatives, monosaccharides, disaccharides, monosaccharide derivatives and disaccharide derivatives and mixtures thereof, especially from the group of glucose and/or fructose and/or ribose and/or maltose and/or lactose and/or sucrose and/or maltodextrin and/or Isomalt®.

The group of the sugars preferred as the matrix material in the context of the present application include, from the group of the mono- and disaccharides and derivatives of mono- and disaccharides, especially glucose, fructose, ribose, maltose, lactose, sucrose, maltodextrin and Isomalt®, and also mixtures of 2, 3, 4 or more mono- and/or disaccharides and/or the derivatives of mono- and/or disaccharides. For instance, particularly preferred matrix materials are mixtures of Isomalt® and glucose, Isomalt® and lactose, Isomalt® and fructose, Isomalt® and ribose, Isomalt® and maltose, glucose and sucrose, Isomalt® and maltodextrin or Isomalt® and sucrose. The proportion by weight of Isomalt® in the total weight of the aforementioned mixtures is preferably at least 20% by weight, more preferably at least 40% by weight and in particular at least 80% by weight.

Also particularly preferred as matrix materials are mixtures of maltodextrin and glucose, maltodextrin and lactose, maltodextrin and fructose, maltodextrin and ribose, maltodextrin and maltose or maltodextrin and sucrose. The proportion by weight of maltodextrin in the total weight of the aforementioned mixtures is preferably at least 20% by weight, more preferably at least 40% by weight and in particular at least 80% by weight.

In the context of the present application, maltodextrin refers to water-soluble carbohydrates obtained by enzymatic degradation of starch (dextrose equivalents, DE 3-20) having a chain length of 5-10 anhydroglucose units and a high proportion of maltose. Maltodextrins are added to foods to improve the Theological and calorific properties, only have a slight sweet taste and do not tend to retrograde. Commercial products, for example from Cerestar, are generally available as spray-dried, free-flowing powders and have a water content of from 3 to 5% by weight.

In the context of the present application, Isomalt® refers to a mixture of 6-O-α-D-glucopyranosyl-D-sorbitol (1,6-GPS) and 1-O-α-D-glucopyranosyl-D-mannitol (1,1-GPM). In a preferred embodiment, the proportion by weight of 1,6-GPS in the total weight of the mixture is less than 57% by weight. Such mixtures can be produced industrially, for example, by enzymatic rearrangement of sucrose to isomaltose and subsequent catalytic hydrogenation of the resulting isomaltose to form an odorless, colorless and crystalline solid.

Matrix materials used with particular preference in the context of the present application are also the sugar acids. Sugar acids can be used advantageously as a constituent of the active phase alone or in combination with other substances, for example the abovementioned sugars, and particularly preferred sugar acids are from the group of gluconic acid, galactonic acid, mannonic acid, fructonic acid, arabinonic acid, xylonic acid, ribonic acid, 2-deoxyribonic acid. Particularly preferred matrix materials also contain Isomalt® in addition to the sugar acids mentioned. The proportion by weight of Isomalt® in the total weight of these mixtures is preferably at least 20% by weight, more preferably at least 40% by weight and in particular at least 80% by weight, and particular preference is given to mixtures of Isomalt® with gluconic acid, Isomalt® with galactonic acid, Isomalt® with mannonic acid, Isomalt® with fructonic acid, Isomalt® with arabinonic acid, Isomalt® with xylonic acid, Isomalt® with ribonic acid and Isomalt® with 2-deoxyribonic acid.

A third group of advantageously usable matrix materials is that of the sugar alcohols, of which preference is given in the context of the present application in particular to mannitol, sorbitol, xylitol, dulcitol and arabitol. The sugar alcohols may be used alone or as mixtures with one another or as a mixture with further sugars, sugar derivatives, sugar acids or sugar acid derivatives. Particular preference is given to using mixtures of sugar alcohols with Isomalt®, and particular preference is given to mixtures of Isomalt® with mannitol, Isomalt® with sorbitol, Isomalt® with xylitol, Isomalt® with dulcitol and Isomalt® with arabitol. The proportion by weight of Isomalt® in the total weight of these mixtures is preferably at least 20% by weight, more preferably at least 40% by weight and in particular at least 80% by weight.

As has been mentioned at the outset, it is an object of this application to incorporate additives having a low proportion by weight in the overall formulation of the detergent tablet with simultaneous direct visualization of the additional function(s) caused by this/these additive(s). The present application preferably provides, for example, detergent tablets whose active phases have washing or cleaning substances with a proportion by weight below 5% by weight, preferably below 4% by weight and in particular below 2% by weight, based in each case on the total weight of the tablet. Since the visual perception of these formulation constituents having a low proportion by weight by the consumer is hindered by their low volume, preference is given in a specific embodiment of the present application to those detergent tablets in which the proportion by weight of the solid matrix in the total weight of the active phase is at least 20% by weight, preferably at least 40% by weight, more preferably at least 80% by weight and in particular at least 90% by weight. However, it has to be noted that the dissolution and release profile of the active phase also changes with the increasing proportion of the matrix material in the total weight of the active phase. It is generally the case that the release of the enclosed washing and/or cleaning substances is delayed with the increasing proportion of the matrix material in the total weight of the active phase.

With regard to an improved appearance, preferred inventive detergent tablets are further characterized in that the proportion by weight of the active phase is at least 5% by weight, preferably at least 7.5% by weight and in particular at least 10% by weight of the total weight of the detergent tablet.

In a particularly preferred embodiment of inventive detergent tablets, the active phase is transparent. In the context of this invention, transparency means that the transmission within the visible spectrum of light (from 410 to 800 nm) is greater than 20%, preferably greater than 30%, extremely preferably greater than 40% and in particular greater than 50%. As soon as one wavelength of the visible spectrum of light has a transmission of greater than 20%, it is to be regarded as transparent in the context of the invention. Transparent active phases improve the overall appearance of inventive tablets and offer a further means of visualization of the washing or cleaning substances which are present in these active phases and may be present in these transparent active phases, for example, as crystals or granules, and are visible to the consumer owing to the transparency of the active phases at least partly enclosing them.

A further means of improving the appearance of inventive active phases consists in coloring them. The active phases of particularly preferred detergent tablets in the context of the present application will accordingly also comprise dyes in addition to matrix material and washing and/or cleaning substances. Preferred dyes, whose selection presents no difficulty whatsoever to those skilled in the art, have a high storage stability and insensitivity toward the other ingredients of the products and toward light, and also no marked substantivity toward items of crockery or textiles in order not to color them.

Preferred colorants for use in the inventive detergents are all of those which can be destroyed oxidatively in the washing and cleaning process and mixtures thereof with suitable blue dyes, known as bluing agents. It has been found to be advantageous to use colorants which are soluble in water or at room temperature in liquid organic substances. Suitable are, for example, anionic colorants, for example anionic nitroso dyes. One possible colorant is, for example, Naphthol Green (Colour Index (CI) Part 1: Acid Green 1; Part 2: 10020) which is obtainable as a commercial product, for example, as Basacid® Green, 970 from BASF, Ludwigshafen, and also mixtures thereof with suitable blue dyes. Further colorants which can be used include Pigmosol® Blue 6900 (CI 74160), Pigmosol® Green 8730 (CI 74260), Basonyl® Red 545 FL (CI 45170), Sandolan® Rhodamine EB400 (CI 45100), Basacid® Yellow 094 (CI 47005), Sicovit® Patent Blue 85 E 131 (CI 42051), Acid Blue 183 (CAS 12217-22-0, CI Acidblue 183), Pigment Blue 15 (CI 74160), Supranol® Blue GLW (CAS 12219-32-8, CI Acidblue 221)), Nylosan® Yellow N-7GL SGR (CAS 61814-57-1, CI Acidyellow 218) and/or Sandolan® Blue (CI Acid Blue 182, CAS 12219-26-0).

In the case of readily water-soluble colorants, for example the abovementioned Basacid® Green or the likewise abovementioned Sandolan® Blue, typical colorant concentrations are selected within the range from a few 10⁻² to 10⁻³% by weight. In the case of the pigment dyes which are especially preferred owing to their brightness but less readily water-soluble, for example the abovementioned Pigmosol® dyes, the suitable concentration of the colorant in the active phase is typically a few 10⁻³ to 10⁻⁴% by weight.

In summary, preferred single- or multiphase detergent tablets in the context of the present invention can also be described to the effect that the active phase contains
a) from 10 to 98% by weight of matrix material,
b) from 1.5 to 90% by weight of one or more washing and/or cleaning substance(s) and
c) from 0 to 1.0% of a dye.

The group of the washing and/or cleaning substances which are present within the single- or multiphase detergent tablet, especially within the inventive active phase, generally include all substances of this type which are known to those skilled in the art, especially individual substances or substance mixtures from the group of bleaches, bleach activators, polymers, builders, surfactants, enzymes, disintegration assistants, electrolytes, pH modifiers, fragrances, perfume carriers, dyes, hydrotropes, foam inhibitors, antiredeposition agents, optical brighteners, graying inhibitors, shrink preventers, anticrease agents, dye transfer inhibitors, active antimicrobial ingredients, germicides, fungicides, antioxidants, corrosion inhibitors, antistats, repellent and impregnation agents, swelling and antislip agents, nonaqueous solvents, fabric softeners, protein hydrolyzates and UV absorbers.

As important constituents of detergents, the inventive products may comprise bleaches and bleach activators in addition to other constituents. Among the compounds which serve as bleaches and afford H₂O₂ in water, sodium perborate tetrahydrate and sodium perborate monohydrate have particular significance. Further usable bleaches are, for example, sodium percarbonate, peroxypyro phosphates, citrate perhydrates and peracidic salts or peracids which afford H₂O₂, such as perbenzoates, peroxophthalates, diperazelaic acid, phthaloimino peracid or diperdodecanedioic acid. Detergent tablets for machine dishwashing may also comprise bleaches from the group of the organic bleaches. Typical organic bleaches are the diacyl peroxides, for example dibenzoyl peroxide. Further typical organic bleaches are the peroxy acids, and particular examples are the alkylperoxy acids and the arylperoxy acids. Preferred representatives are (a) peroxybenzoic acid and its ring-substituted derivatives such as alkylperoxybenzoic acids, but also peroxy-α-naphthoic acid and magnesium monoperphthalate, (b) the aliphatic or substituted aliphatic peroxy acids such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids such as 1,12-diperoxylauric acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid) may be used.

When the inventive products are used as machine dishwasher rinse aids, they may comprise bleach activators in order to achieve improved bleaching action in the course of cleaning at temperatures of 60° C. and below. The bleach activators used may be compounds which, under perhydrolysis conditions, give rise to aliphatic peroxocarboxylic acids having preferably from 1 to 10 carbon atoms, in particular from 2 to 4 carbon atoms, and/or optionally substituted perbenzoic acid. Suitable substances bear O— and/or N-acyl groups of the carbon atom number mentioned and/or optionally substituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acylimides, especially N-nonanoylsuccinimide (NOSI), acylated phenolsulfonates, especially n-nonanoyl- or isononanoyloxybenzenesulfonate (n- or iso-NOBS), carboxylic anhydrides, especially phthalic anhydride, acylated polyhydric alcohols, especially triacetin, ethylene glycol diacetate and 2,5-diacetoxy-2,5-dihydrofuran.

In addition to the conventional bleach activators or in their stead, it is also possible to incorporate bleach catalysts into the products. These substances are bleach-boosting transition metal salts or transition metal complexes, for example salen complexes or carbonyl complexes of Mn, Fe, Co, Ru or Mo. It is also possible to use, as bleach catalysts, complexes of Mn, Fe, Co, Ru, Mo, Ti, V and Cu with N-containing tripod ligands, and also Co—, Fe—, Cu— and Ru-ammine complexes.

In the context of the present application, preferred detergents comprise one or more surfactant(s) from the groups of the anionic, nonionic, cationic and/or amphoteric surfactants.

The anionic surfactants used in acid form are preferably one or more substances from the group of the carboxylic acids, the sulfuric monoesters and the sulfonic acids, preferably from the group of the fatty acids, the fatty alkylsulfuric acids and the alkylarylsulfonic acids. In order to have sufficient surface-active properties, the compounds mentioned should have relatively long-chain hydrocarbon radicals, i.e. have at least 6 carbon atoms in the alkyl or alkenyl radical. Typically, the carbon chain distributions of the anionic surfactants are in the range from 6 to 40, preferably from 8 to 30 and in particular from 12 to 22 carbon atoms.

Carboxylic acids which find use as soaps in detergents in the form of their alkali metal salts are obtained industrially for the most part from native fats and oils by hydrolysis. While the alkaline hydrolysis which was carried out even in the nineteenth century led directly to the alkali metal salts (soaps), the practice today is to use only water for hydrolysis on the industrial scale, which hydrolyzes the fats into glycerol and the free acids. Processes employed on the industrial scale are, for example, hydrolysis in an autoclave or continuous high-pressure hydrolysis. In the context of the present invention, carboxylic acids which can be used in acid form as anionic surfactants are, for example, hexanoic acid (caproic acid), heptanoic acid (enanthic acid), octanoic acid (caprylic acid), nonanoic acid (pelargonic acid), decanoic acid (capric acid), undecanoic acid, etc. Preference is given in the context of the present invention to the use of fatty acids such as dodecanoic acid (lauric acid), tetradecanoic acid (myristic acid), hexadecanoic acid (palmitic acid), octadecanoic acid (stearic acid), eicosanoic acid (arachic acid), docosanoic acid (behenic acid), tetracosanoic acid (lignoceric acid), hexacosanoic acid (cerotic acid), triacotanoic acid (melissic acid), and also the unsaturated species 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienedioic acid (linolaidic acid) and 9c,12c,15c-octadecatrienoic acid (linolenic acid). For reasons of cost, preference is given not to using the pure species, but rather technical mixtures of the individual acids, as obtainable from fat hydrolysis. Such mixtures are, for example, coconut oil fatty acid (approx. 6% by weight of C₈, 6% by weight of C₁₀, 48% by weight of C₁₂, 18% by weight of C₁₄, 10% by weight of C₁₆, 2% by weight of C₁₈, 8% by weight of C_{18′}, 1% by weight of C_{18″}), palm kernel oil fatty acid (approx. 4% by weight of C₈, 5% by weight of C₁₀, 50% by weight of C₁₂, 15% by weight of C₁₄, 7% by weight of C₁₆, 2% by weight of C₁₈, 15% by weight of C_{18′}, 1% by weight of C_{18″}), tallow fatty acid (approx. 3% by weight of C₁₄, 26% by weight of C₁₆, 2% by weight of C_{16′}, 2% by weight of C₁₇, 17% by weight of C₁₈, 44% by weight of C_{18′}, 3% by weight of C_{18″}, 1% by weight of C_{18″′}), hardened tallow fatty acid (approx. 2% by weight of C₁₄, 28% by weight of C₁₆, 2% by weight of C₁₇, 63% by weight of C₁₈, 1% by weight of C_{18′}), technical oleic acid (approx. 1% by weight of C₁₂, 3% by weight of C₁₄, 5% by weight of C₁₆, 6% by weight of C_{16′}, 1% by weight of C₁₇, 2% by weight of C₁₈, 70% by weight of C_{18′}, 10% by weight of C_{18″}, 0.5% by weight of C_{18′″}), technical palmitic/stearic acid (approx. 1% by weight of C₁₂, 2% by weight of C₁₄, 45% by weight of C₁₆, 2% by weight of C₁₇, 47% by weight of C_{18′}, 1% by weight of C_{18′}) and soybean oil fatty acid (approx. 2% by weight of C₁₄, 15% by weight of C₁₆, 5% by weight of C₁₈, 25% by weight of C_{18′}, 45% by weight of C_{18″}, 7% by weight of C_{18′″}).

Sulfuric monoesters of relatively long-chain alcohols are likewise anionic surfactants in their acid form and can be used in the context of the present invention. Their alkali metal salts, especially sodium salts, the fatty alcohol sulfates, are obtainable on the industrial scale from fatty alcohols which are reacted with sulfuric acid, chlorosulfonic acid, amidosulfonic alcohols or sulfur trioxide to give the alkylsulfuric acids in question and subsequently neutralized. The fatty alcohols are obtained from the fatty acids or fatty acid mixtures in question by high-pressure hydrogenation of the fatty acid methyl esters. The quantitatively most significant industrial process for the preparation of fatty alkyl sulfuric acids is the sulfonation of the alcohols with SO₃/air mixtures in special battery, falling-film or tube bundle reactors.

A further class of anionic surfactant acids which can be used in accordance with the invention is that of the alkyl ether sulfuric acids whose salts, the alkyl ether sulfates, feature higher water solubility and lower sensitivity toward water hardness (solubility of the calcium salts) in comparison to the alkyl sulfates. Like the alkyl sulfuric acids, alkyl ether sulfuric acids are synthesized from fatty alcohols which are reacted with ethylene oxide to give the fatty alcohol ethoxylates in question. Instead of ethylene oxide, it is also possible to use propylene oxide. The subsequent sulfonation with gaseous sulfur trioxide in short-path sulfonation reactors affords yields of above 98% of the alkyl ether sulfuric acids in question.

In the context of the present invention, it is also possible to use alkanesulfonic acids and olefinsulfonic acids as anionic surfactants in acid form. Alkanesulfonic acids may contain the sulfonic acid group in terminally bonded form (primary alkanesulfonic acids) or along the carbon chain (secondary alkanesulfonic acids), but only the secondary alkanesulfonic acids are of commercial significance. They are prepared by sulfochlorination or sulfoxidation of linear hydrocarbons. In the Reed sulfochlorination, n-paraffins are reacted with sulfur dioxide and chlorine with irradiation with UV light to give the corresponding sulfochlorides which on hydrolysis with alkalis directly afford the alkanesulfonates, on reaction with water the alkanesulfonic acids. Since di- and polysulfochlorides and also chlorinated hydrocarbons can occur as by-products of the free-radical reaction in the course of the sulfochlorination, the reaction is typically carried out only up to degrees of conversion of 30% and then terminated.

Another process for the preparation of alkanesulfonic acids is sulfoxidation, in which n-paraffins are reacted with sulfur dioxide and oxygen under irradiation with UV light. In this free-radical reaction, alkylsulfonyl radicals are formed gradually and react further with oxygen to give the alkylpersulfonyl radicals. The reaction with unconverted paraffin affords an alkyl radical and the alkylpersulfonic acid which decomposes into an alkylperoxysulfonyl radical and a hydroxyl radical. The reaction of the two radicals with unconverted paraffin affords the alkylsulfonic acids or water which reacts with alkylpersulfonic acid and sulfur dioxide to give sulfuric acid. In order to keep the yield of the two end products, alkylsulfonic acid and sulfuric acid, very high and to suppress side reactions, this reaction is typically only carried out up to degrees of conversion of 1% and then terminated.

Olefinsulfonates are prepared industrially by the reaction of α-olefins with sulfur trioxide. This forms zwitterions as an intermediate, which cyclize to give sultones. Under suitable conditions (alkaline or acidic hydrolysis), these sulfones react to give hydroxyalkanesulfonic acids or alkenesulfonic acids, both of which may likewise be used as anionic surfactant acids.

Alkylbenzenesulfonates as high-performance anionic surfactants have been known since the 1930s. At that time, monochlorination of “kogasin” fractions and subsequent Friedel-Crafts alkylation were used to prepare alkylbenzenes which were sulfonated with oleum and neutralized with sodium hydroxide solution. At the start of the 1950s, alkylbenzenesulfonates were prepared by tetramerizing propylene to give branched α-dodecylene, and the product was converted by a Friedel-Crafts reaction using aluminum trichloride or hydrogen fluoride to tetrapropylenebenzene which was subsequently sulfonated and neutralized. This economic means of preparing tetrapropylenebenzenesulfonates (TPS) led to the breakthrough for this class of surfactant, which subsequently replaced soaps as the main surfactant in detergents.

Owing to the inadequate biodegradability of TPS, there is a need to provide novel alkylbenzenesulfonates which are characterized by improved ecological performance. These requirements are satisfied by linear alkylbenzenesulfonates, which are nowadays almost the only alkylbenzenesulfonates prepared and are denoted by the abbreviation ABS or LAS.

Linear alkylbenzenesulfonates are prepared from linear alkylbenzenes which in turn are obtainable from linear olefins. For this purpose, petroleum fractions are separated on the industrial scale into the n-paraffins of the desired purity using molecular sieves and dehydrogenated to give the n-olefins, resulting in both α- and isoolefins. The resulting olefins are then reacted in the presence of acidic catalysts with benzene to give the alkylbenzenes, the selection of the Friedel-Crafts catalyst having an influence on the isomer distribution of the resulting linear alkylbenzenes: when aluminum trichloride is used, the content of the 2-phenyl isomers in the mixture with the 3-, 4-, 5- and other isomers is approx. 30% by weight; if, on the other hand, the catalyst used is hydrogen fluoride, the content of 2-phenyl isomer can be reduced to approx. 20% by weight. Finally, the linear alkylbenzenes are nowadays sulfonated on the industrial scale with oleum, sulfuric acid or gaseous sulfur trioxide, of which the latter is by far the most significant. For the sulfonation, special film or tube-bundle reactors are used and afford, as the product, 97% by weight alkylbenzenesulfonic acid (ABSA), which can be used as the anionic surfactant acid in the context of the present invention.

The selection of the neutralizing agent makes it possible to obtain a very wide variety of salts, i e, alkylbenzenesulfonates, from ABSA. For economic reasons, preference- is given to preparing and using the alkali metal salts and, among these, preferably the sodium salts of ABSA. These can be described by the general formula I: 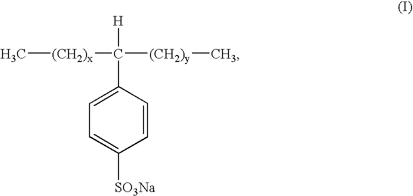
in which the sum of x and y is typically between 5 and 13. Anionic surfactants in acid form which are preferred in accordance with the invention are C₈₋₁₆-, preferably C₉₋₁₃-alkylbenzenesulfonic acids. In the context of the present invention, preference is also given to using C₈₋₁₆-, preferably C₉₋₁₃-alkylbenzenesulfonic acids which derive from alkylbenzenes which have a tetralin content below 5% by weight, based on the alkylbenzene. Preference is further given to using alkylbenzenesulfonic acids whose alkylbenzenes have been prepared by the HF process, so that the C₈₋₁₆-, preferably C₉₋₁₃-alkylbenzenesulfonic acids used have a content of 2-phenyl isomer below 22% by weight, based on the alkylbenzenesulfonic acid.

The aforementioned anionic surfactants in their acid form may be used alone or in a mixture with one another. However, it is also possible and preferred that further, preferably acidic, ingredients of detergents be added in amounts of from 0.1 to 40% by weight, preferably from 1 to 15% by weight and in particular from 2 to 10% by weight, based in each case on the weight of the mixture to be converted, to the anionic surfactant in acid form before it is added to the carrier material(s).

In addition to the surfactant acids, suitable acidic reaction partners in the context of the present invention are also the fatty acids, phosphonic acids, polymer acids or semineutralized polymer acids mentioned, and “builder acids” and “complex builder acids” (details later in the text), alone and in any mixtures. Possible ingredients of detergents are in particular acidic detergent ingredients, i.e., for example, phosphonic acids which, in neutralized form (phosphonates) as incrustation inhibitors, are a constituent of many detergents. It is also possible in accordance with the invention to use (semineutralized) polymer acids, for example polyacrylic acids. However, it is also possible to mix acid-stable ingredients with the anionic surfactant acid. Useful for this purpose are, for example, “small components” which would otherwise have to be added in complicated further steps, i.e., for example, optical brighteners, dyes etc., although it is necessary to check the acid stability in the individual case.

It will be appreciated that it is also possible to use the anionic surfactants in semineutralized or fully neutralized form. In that case, these salts may be present as a solution, suspension or emulsion in the granulation liquid but may also be part of the fixed bed as a solid. Possible cations for such anionic surfactants are, in addition to the alkali metals (here in particular sodium and potassium salts), ammonium and mono-, di- or triethanolalkonium ions. Instead of mono-, di- or triethanolamine, it is also possible for the analogous representatives of mono-, di- or trimethanolamine or those of the alkanolamines of higher alcohols to be quaternized and to be present as the cation.

A further group of washing substances is that of the nonionic surfactants. The nonionic surfactants used are preferably alkoxylated, advantageously ethoxylated, especially primary alcohols having preferably from 8 to 18 carbon atoms and, on average, from 1 to 12 mol of ethylene oxide (EO) per mole of alcohol, in which the alcohol radical may be linear or preferably methyl-branched in the 2-position or the mixture may contain linear and methyl-branched radicals, as are typically present in oxo alcohol radicals. However, preference is given in particular to alcohol ethoxylates having linear radicals from alcohols of native origin having from 12 to 18 carbon atoms, for example from coconut, palm, tallow fat or oleyl alcohol and on average from 2 to 8 EO per mole of alcohol. Examples of preferred ethoxylated alcohols include, for example, C₁₂₋₁₄ alcohols having 3 EO or 4 EO, C₉₋₁₁ alcohols having 7 EO, C₁₃₋₁₅ alcohols having 3 EO, 5 EO, 7 EO or 8 EO, C₁₂₋₁₈ alcohols having 3 EO, 5 EO or 7 EO and mixtures of these, such as mixtures of C₁₂₋₁₄ alcohol having 3 EO and C₁₂₋₁₈ alcohol having 5 EO. The degrees of ethoxylation specified constitute statistical averages which may be an integer or a fraction for a specific product. Preferred alcohol ethoxylates have a narrow homolog distribution (narrow range ethoxylates, NRE). In addition to these nonionic surfactants, fatty alcohols having more than 12 EO may also be used. Examples thereof are tallow fat alcohol having 14 EO, 25 EO, 30 EO or 40 EO.

A further class of nonionic surfactants used with preference, which are used either as the sole nonionic surfactant or in combination with other nonionic surfactants, is that of alkoxylated, preferably ethoxylated or ethoxylated and propoxylated, fatty acid alkyl esters, preferably having from 1 to 4 carbon atoms in the alkyl chain, especially fatty acid methyl esters.

A further class of nonionic surfactants which may be used advantageously is that of the alkylpolyglycosides (APG). Alkylpolyglycosides which can be used satisfy the general formula RO(G)_{z} in which R is a linear or branched, especially 2-methyl-branched, saturated or unsaturated aliphatic radical having from 8 to 22, preferably from 12 to 18, carbon atoms, and G is the symbol which represents a glycose unit having 5 or 6 carbon atoms, preferably glucose. The degree of glycosidation z is between 1,0 and 4.0, preferably between 1.0 and 2.0, and in particular between 1.1 and 1.4. Preference is given to using linear alkylpolyglucosides, i.e. alkylpolyglycosides which consist of a glucose radical and an n-alkyl chain.

A further class of nonionic surfactants used with preference, which are used either as the sole nonionic surfactant or in combination with other nonionic surfactants, is that of alkoxylated, preferably ethoxylated or ethoxylated and propoxylated, fatty acid alkyl esters, preferably having from 1 to 4 carbon atoms in the alkyl chain.

Nonionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The amount of these nonionic surfactants is preferably not more than that of the ethoxylated fatty alcohols, in particular not more than half thereof.

Further suitable surfactants are polyhydroxy fatty acid amides of the formula (II) 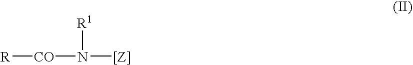
in which RCO is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can be obtained typically by reductively aminating a reducing sugar with ammonia, an alkylamine or an alkanolamine and subsequently acylating with a fatty acid, a fatty acid alkyl ester or a fatty acid chloride.

The group of the polyhydroxy fatty acid amides also includes compounds of the formula (III) 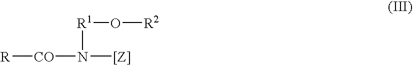
in which R is a linear or branched alkyl or alkenyl radical having from 7 to 12 carbon atoms, R¹ is a linear, branched or cyclic alkyl radical or an aryl radical having from 2 to 8 carbon atoms, and R² is a linear, branched or cyclic alkyl radical or an aryl radical or an oxyalkyl radical having from 1 to 8 carbon atoms, of which preference is given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductively aminating a reduced sugar, for example glucose, fructose, maltose, lactose, galactose, mannose or xylose. The N-alkoxy- or N-aryloxy-substituted compounds may then be converted to the desired polyhydroxy fatty acid amides by reacting with fatty acid methyl esters in the presence of an alkoxide as a catalyst,

In detergents for machine dishwashing, useful surfactants are generally all surfactants. However, preference is given for this application to the above-described nonionic surfactants and here in particular the low-foaming nonionic surfactants. Particular preference is given to the alkoxylated alcohols, particularly the ethoxylated and/or propoxylated alcohols. Those skilled in the art will generally regard alkoxylated alcohols as being the reaction products of alkylene oxide, preferably ethylene oxide, with alcohols, preferably in the context of the present invention the relatively long-chain alcohols (C₁₀ to C₁₈, preferably between C₁₂ and C₁₆, for example C₁₁, C₁₂, C₁₃, C₁₄, C₁₅, C₁₆, C₁₇ and C₁₈ alcohols). In general, n moles of ethylene oxide and 1 mole of alcohol, depending on the reaction conditions, form a complex mixture of addition products of different degrees of ethoxylation. A further embodiment consists in the use of mixtures of alkylene oxides, preferably of the mixture of ethylene oxide and propylene oxide. It is also possible if desired, by a final etherification with short-chain alkyl groups, preferably the butyl group, to obtain the substance class of the “capped” alcohol ethoxylates which may likewise be used in the context of the invention. In the context of the present invention, very particular preference is given to using highly ethoxylated fatty alcohols or mixtures thereof with end group-capped fatty alcohol ethoxylates.

Particularly preferred nonionic surfactants in the context of the present invention have been found to be low-foaming nonionic surfactants which have alternating ethylene oxide and alkylene oxide units. Among these, preference is given in turn to surfactants having EO-AO-EO-AO blocks, and in each case from 1 to 10 EO and/or AO groups are bonded to one another before a block of the other groups in each case follows. Preference is given here to inventive machine dishwasher detergents which comprise, as nonionic surfactant(s), surfactants of the general formula (IV) 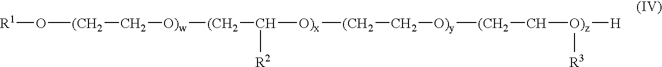
in which R¹ is a straight-chain or branched, saturated or mono- or polyunsaturated C₆₋₂₄-alkyl or -alkenyl radical; each R² or R³ group is independently selected from —CH₃; —CH₂CH₃, —CH₂CH₂CH₃, —CH(CH₃)₂ and the indices w, x, y, z are each independently integers from 1 to 6.

The preferred nonionic surfactants of the formula IV can be prepared by known methods from the corresponding alcohols R¹—OH and ethylene oxide or alkylene oxide. The R¹ radical in the above formula I may vary depending on the origin of the alcohol. When native sources are utilized, the R¹ radical has an even number of carbon atoms and is generally unbranched, and preference is given to the linear radicals of alcohols of native origin having from 12 to 18 carbon atoms, for example from coconut, palm, tallow fat or oleyl alcohol. Alcohols obtainable from synthetic sources are, for example, the Guerbet alcohols or 2-methyl-branched or linear and methyl-branched radicals in a mixture, as are typically present in oxo alcohol radicals. Irrespective of the type of the alcohol used to prepare the nonionic surfactants present in accordance with the invention in the products, preference is given to inventive machine dishwasher detergents in which R¹ in formula I is an alkyl radical having from 6 to 24, preferably from 8 to 20, more preferably 9 to 15 and in particular 9 to 11 carbon atoms.

The alkylene oxide unit which is present in the preferred nonionic surfactants in alternation to the ethylene oxide unit is, as well as propylene oxide, especially butylene oxide. However, further alkylene oxides in which R² and R³ are each independently selected from —CH₂CH₂—CH₃ and —CH(CH₃)₂ are also suitable. Preferred machine dishwasher detergents are characterized in that R² and R³ are each a —CH₃ radical, w and x are each independently values of 3 or 4 and y and z are each independently values of 1 or 2.

In summary, preference is given for use in the inventive products especially to nonionic surfactants which have a C₉₋₁₅ alkyl radical having from 1 to 4 ethylene oxide units, followed by from 1 to 4 propylene oxide units, followed by from 1 to 4 ethylene oxide units, followed by from 1 to 4 propylene oxide units.

The additional surfactants used with preference are low-foaming nonionic surfactants. When the inventive single- or multiphase detergent tablets are used for machine dishwashing, they contain with particular preference a nonionic surfactant which has a melting point above room temperature. Accordingly, preferred products are characterized in that they comprise nonionic surfactant(s) having a melting point above 20° C., preferably above 25° C., more preferably between 25 and 60° C. and in particular between 26.6 and 43.3° C.

In addition to the nonionic surfactants present in accordance with the invention in the products, suitable nonionic surfactants which have melting or softening points within the temperature range specified are, for example, low-foaming nonionic surfactants which may be solid or highly viscous at room temperature. When highly viscous nonionic surfactants are used at room temperature, it is preferred that they have a viscosity above 20 Pas, preferably above 35 Pas and in particular above 40 Pas. Preference is also given to nonionic surfactants which have waxlike consistency at room temperature.

Preferred nonionic surfactants solid at room temperature which are to be used stem from the group of the alkoxylated nonionic surfactants, especially of the ethoxylated primary alcohols and mixtures of these surfactants with surfactants having a complicated structure, such as polyoxypropylene/polyoxyethylene/polyoxypropylene (PO/EO/PO) surfactants. Such (PO/EO/PO) nonionic surfactants additionally feature good foam control.

In a preferred embodiment of the present invention, the nonionic surfactant having a melting point above room temperature is an ethoxylated nonionic surfactant which arises from the reaction of a monohydroxyalkanol or alkylphenol having from 6 to 20 carbon atoms with preferably at least 12 mol, more preferably at least 15 mol, in particular at least 20 mol, of ethylene oxide per mole of alcohol or alkylphenol.

A particularly preferred nonionic surfactant solid at room temperature which is to be used is obtained from a straight-chain fatty alcohol having from 16 to 20 carbon atoms (C₁₆₋₂₀ alcohol), preferably a C₁₈ alcohol, and at least 12 mol, preferably at least 15 mol and in particular at least 20 mol, of ethylene oxide. Particular preference among these is given to the narrow range ethoxylates (see above).

Accordingly, particularly preferred inventive products comprise ethoxylated nonionic surfactant(s) which has/have been obtained from C₆₋₂₀ monohydroxyalkanols or C₆₋₂₀ alkylphenols or C₁₆₋₂₀ fatty alcohols and more than 12 mol, preferably more than 15 mol and in particular more than 20 mol, of ethylene oxide per mole of alcohol.

The nonionic surfactant preferably additionally has propylene oxide units in the molecule. Such PO units preferably make up up to 25% by weight, more preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably makes up more than 30% by weight, more preferably more than 50% by weight and in particular more than 70% by weight, of the total molar mass of such nonionic surfactants. Preferred machine dishwasher detergents are characterized in that they contain ethoxylated and propoxylated nonionic surfactants in which the propylene oxide units in the molecule make up up to 25% by weight, preferably up to 20% by weight and in particular up to 15% by weight, of the total molar mass of the nonionic surfactant.

Further nonionic surfactants having melting points above room temperature which are to be used with particular preference contain from 40 to 70% of a polyoxypropylene/polyoxyethylene/polyoxypropylene block polymer blend which contains 75% by weight of a reverse block copolymer of polyoxyethylene and polyoxypropylene having 17 mol% of ethylene oxide and 44 mol% of propylene oxide and 25% by weight of a block copolymer of polyoxyethylene and polyoxypropylene initiated with trimethylolpropane and containing 24 mol of ethylene oxide and 99 mol of propylene oxide per mole of trimethylolpropane.

Nonionic surfactants which can be used with particular preference are available, for example, from Olin Chemicals under the name Poly Tergent® SLF-18.

A further preferred inventive machine dishwasher detergent comprises nonionic surfactants of the formula
R¹O[CH₂CH(CH₃)O]ₓ[CH₂CH₂O]_{y}[CH₂CH(OH)R²],
in which R¹ is a linear or branched aliphatic hydrocarbon radical having from 4 to 18 carbon atoms or mixtures thereof, R² is a linear or branched hydrocarbon radical having from 2 to 26 carbon atoms or mixtures thereof, and x is a value between 0.5 and 1.5, and y is a value of at least 15.

Further nonionic surfactants which can be used with preference are the end group-capped poly(oxyalkylated) nonionic surfactants of the formula
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is a value between 1 and 30, k and j represent values between 1 and 12, preferably between 1 and 5. If the value x is ≧2, each R³ in the above formula may be different. R¹ and R² are preferably linear or branched, saturated or unsaturated, aliphatic or aromatic hydrocarbon radicals having from 6 to 22 carbon atoms, and particular preference is given to radicals having from 8 to 18 carbon atoms. For the R³ radical, particular preference is given to H, —CH₃ or —CH₂CH₃. Particularly preferred values for x are in the range from 1 to 20, in particular from 6 to 15.

As described above, each R³ in the above formula may be different if x is ≧2. This allows the alkylene oxide unit in the square brackets to be varied. If x, for example, is 3, the R³ radical may be selected so as to form ethylene oxide (R³═H) or propylene oxide (R³═CH₃) units, which may be added to one another in any sequence, for example (EO) (PO) (EO), (EO) (EO) (PO), (EO) (EO) (EO), (PO) (EO) (PO), (PO) (PO) (EO) and (PO) (PO) (PO). The value 3 for x has been selected here by way of example and it is entirely possible for it to be larger, the scope of variation increasing with increasing values of x and including, for example, a large number of (EO) groups combined with a small number of (PO) groups, or vice versa.

Especially preferred end group-capped poly(oxyalkylated) alcohols of the above formula have values of k=1 and j=1, so as to simplify the above formula to
R¹O[CH₂CH(R³)O]ₓCH₂CH(OH)CH₂OR²

In the latter formula, R¹, R² and R³ are each as defined above and x represents numbers from 1 to 30, preferably from 1 to 20 and in particular from 6 to 18. Particular preference is given to surfactants in which the R¹ and R² radicals have from 9 to 14 carbon atoms, R³ is H, and x assumes values from 6 to 15.

Summarizing the latter statements, preference is given to inventive products with active phase which contain end group-capped poly(oxyalkylated) nonionic surfactants of the formula
R¹O[CH₂CH(R³)O]ₓ[CH₂]ₖCH(OH)[CH₂]ⱼOR²
in which R¹ and R² are each linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is a value between 1 and 30, k and j are values between 1 and 12, preferably between 1 and 5, and particular preference is given to surfactants of the
R¹O[CH₂CH(R³)O]ₓCH₂CH(OH)CH₂OR²
type in which x represents numbers from 1 to 30, preferably from 1 to 20 and in particular from 6 to 18.

In conjunction with the surfactants mentioned, it is also possible to use anionic, cationic and/or amphoteric surfactants, although, owing to their foaming behavior in machine dishwashing detergents, they are only of minor importance and are usually used only in amounts below 10% by weight, in most cases even below 5% by weight, for example from 0.01 to 2.5% by weight, based in each case on the agent. The inventive agents can thus also comprise anionic, cationic and/or amphoteric surfactants as the surfactant component.

In the context of the present invention, it is preferred that, when an inventive product is used as a machine dishwasher detergent, surfactant(s), therein preferably nonionic surfactant(s) are present in amounts of from 0.5 to 10% by weight, preferably from 0.75% to 7.5% by weight and in particular from 1.0 to 5% by weight, based in each case on the overall product.

It is advantageously also possible to use cationic surfactants as the washing or cleaning substance. The cationic surfactant may be added directly into the mixer in its supply form, or be sprayed onto the solid support in the form of a liquid to pasty cationic surfactant preparation form. Such cationic surfactant preparation forms can be prepared, for example, by mixing commercial cationic surfactants with assistants such as nonionic surfactants, polyethylene glycols or polyols. It is also possible to use lower alcohols such as ethanol and isopropanol, in which case the amount of such lower alcohols in the liquid cationic surfactant preparation form should, for the abovementioned reasons, be below 10% by weight.

Useful cationic surfactants for the inventive products include all customary substances, and there is a distinct preference for cationic surfactants having textile-softening action.

The inventive products may comprise, as cationic active substances having textile-softening action, one or more cationic, textile-softening agents of the formula V, VI or VII: 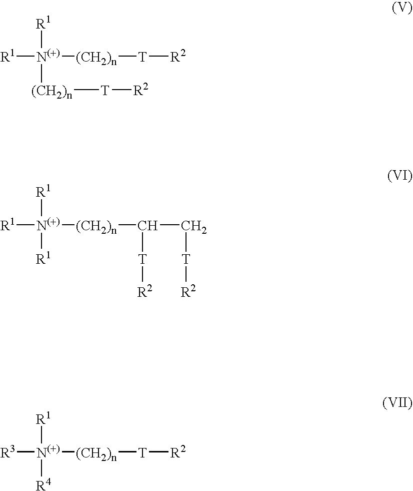
where each R¹ group is independently selected from C₁₋₆-alkyl, -alkenyl or -hydroxyalkyl groups; each R² group is independently selected from C₈₋₂₈-alkyl or -alkenyl groups; R³═R¹ or (CH₂)ₙ-T-R²; R⁴═R¹ or R² or (CH₂)ₙ-T-R²; T=—CH₂—, —O—CO— or —CO—O— and n is an integer from 0 to 5.

In preferred embodiments of the present invention, the solid(s) additionally comprise(s) nonionic surfactant(s) as washing or cleaning substances.

In addition to the ingredients mentioned, bleach and bleach activator and the surfactants, builders are further important ingredients of detergents. The inventive products may comprise all builders customarily used in detergents, i.e. especially zeolites, silicates, carbonates, organic cobuilders and, where there are no ecological objections to their use, also the phosphates. It will be appreciated that the builders mentioned may also be used in surfactant-free compacts.

Suitable crystalline, sheet-type sodium silicates have the general formula NaMSiₓO₂ₓ₊₁.H₂O where M is sodium or hydrogen, x is a number from 1.9 to 4, y is a number from 0 to 20, and preferred values for x are 2, 3 or 4. Preferred crystalline sheet silicates of the formula specified are those in which M is sodium and x assumes the values 2 or 3. In particular, preference is given to both β- and also δ-sodium disilicates Na₂Si₂O₅.yH₂O.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retardation of dissolution relative to conventional amorphous sodium silicates may have been brought about in a variety of ways, for example by surface treatment, compounding, compacting or by overdrying. In the context of this invention, the term “amorphous” also includes “X-ray-amorphous”. This means that, in X-ray diffraction experiments, the silicates do not afford any sharp X-ray reflections typical of crystalline substances, but rather yield at best one or more maxima of the scattered X-radiation, which have a width of several degree units of the diffraction angle. However, it may quite possibly lead to even particularly good builder properties if the silicate particles in electron diffraction experiments yield vague or even sharp diffraction maxima. This is to be interpreted such that the products have microcrystalline regions with a size of from 10 to several hundred nm, and preference is given to values up to a maximum of 50 nm and in particular up to a maximum of 20 nm. Such X-ray-amorphous silicates likewise have retarded dissolution compared with conventional waterglasses. Particular preference is given to compacted amorphous silicates, compounded amorphous silicates and overdried X-ray-amorphous silicates.

The finely crystalline synthetic zeolite used, containing bound water, is preferably zeolite A and/or P. Zeolite P is particularly preferably Zeolite MAP® (commercial product from Crosfield). Also suitable, however, are zeolite X, and mixtures of A, X and/or P. Also commercially available and usable in accordance with the invention is, for example, a cocrystal of zeolite X and zeolite A (about 80% by weight of zeolite X), which is sold by CONDEA Augusta S.p.A. under the trade name VEGOBOND AX® and can be described by the formula
nNa₂O.(1-n)K₂O.Al₂O₃.(2-2.5)SiO₂.(3.5-5.5)H₂O.

Suitable zeolites have an average particle size of less than 10 μm (volume distribution; measurement method: Coulter Counter) and preferably contain 18 to 22% by weight, in particular 20 to 22% by weight, of bound water.

It will be appreciated that it is also possible to use the commonly known phosphates as builder substances, as long as such a use is not to be avoided for ecological reasons. Especially suitable are the sodium salts of the orthophosphates, of the pyrophosphates and especially of the tripolyphosphates.

Alkali metal phosphates is the collective term for the alkali metal (especially sodium and potassium) salts of the various phosphoric acids, for which a distinction may be drawn between metaphosphoric acids (HPO₃)ₙ and orthophosphoric acid H₃PO₄, in addition to higher molecular weight representatives. The phosphates combine a number of advantages: they act as alkali carriers, prevent limescale deposits on machine components and lime encrustations in fabrics, and additionally contribute to the cleaning performance.

Sodium dihydrogenphosphate, NaH₂PO₄, disodium hydrogenphosphate (secondary sodium phosphate), Na₂HPO₄, trisodium phosphate, tertiary sodium phosphate, Na₃PO₄, tetrasodium diphosphate (sodium pyrophosphate), Na₄P₂O₇, and higher molecular weight sodium and potassium phosphates which are formed by condensation of NaH₂PO₄ and of KH₂PO₄ respectively, for which a distinction can be drawn between cyclic representatives, the sodium and potassium metaphosphates, and catenated types, the sodium and potassium polyphosphates, just like pentasodium triphosphate, Na₅P₃O₁₀ (sodium tripolyphosphate), further builders used advantageously in the context of the present application.

Organic builder substances which can be used are, for example, the polycarboxylic acids usable in the form of their alkali metal and especially sodium salts, such as citric acid, adipic acid, succinic acid, glutaric acid, tartaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

Alkali carriers may be present as further constituents. Alkali carriers include alkali metal hydroxides, alkali metal carbonates, alkali metal hydrogencarbonates, alkali metal sesquicarbonates, alkali metal silicates, alkali metal metasilicates and mixtures of the aforementioned substances, and particular preference is given in the context of this invention to using the alkali metal carbonates, especially sodium carbonate, sodium hydrogencarbonate or sodium sesquicarbonate.

When the inventive products are used for machine dishwashing, preference is given to water-soluble builders, since they have a lesser tendency to form insoluble residues on crockery and hard surfaces. Typical builders are the low molecular weight polycarboxylic acids and salts thereof, the homopolymeric and copolymeric polycarboxylic acids and salts thereof, the carbonates, phosphates and silicates. For the production of tablets for machine dishwashing, preference is given to using trisodium citrate and/or pentasodium tripolyphosphate and/or sodium carbonate and/or sodium bicarbonate and/or gluconates and/or silicatic builders from the class of the disilicates and/or metasilicates. Particular preference is given to a builder system comprising a mixture of tripolyphosphate and sodium carbonate. Particular preference is likewise given to a builder system which comprises a mixture of tripolyphosphate and sodium carbonate and sodium disilicate.

Useful enzymes are those from the classes of the proteases, lipases, amylases, cellulases and mixtures thereof. Particularly suitable active enzymatic ingredients are those obtained from bacteria strains or fungi such as Bacillus subtilis, Bacillus licheniformis and Streptomyces griseus. Preference is given to using proteases of the subtilisin type and especially proteases which are obtained from Bacillus lentus. Of particular interest in this connection are enzyme mixtures, for example of protease and amylase or protease and lipase or protease and cellulase or of cellulase and lipase or of protease, amylase and lipase or protease, lipase and cellulase, but in particular cellulase-containing mixtures. Peroxidases or oxidases have also been found to be suitable in some cases. The enzymes may be adsorbed on carrier substances and/or be embedded in coating substances in order to protect them against premature decomposition.

In order to ease the decomposition of the inventive products, these products may comprise disintegration assistants, known as tablet disintegrants. Tablet disintegrants or disintegration accelerators refer to assistants according to Römpp (9th edition, vol. 6, p. 4440) and Voigt “Lehrbuch der pharmazeutischen Technologie” [Textbook of pharmaceutical technology] (6th edition, 1987, p. 182-184) which ensure the rapid decomposition of tablets in water or gastric juice and the release of pharmaceuticals in absorbable form.

These substances which are also referred to as “breakup” agents owing to their action increase their volume on entry of water, and it is either the increase in the intrinsic volume (swelling) or the release of gases that can generate a pressure that causes the tablets to disintegrate into smaller particles. Disintegration assistants which have been known for some time are, for example, carbonate/citric acid systems, although other organic acids may also be used. Swelling disintegration assistants are, for example, synthetic polymers such as polyvinylpyrrolidone (PVP) or natural polymers or modified natural substances such as cellulose and starch and derivatives thereof, alginates or casein derivatives. All disintegration assistants mentioned can be used in accordance with the invention.

Preferred disintegration assistants used in the context of the present invention are disintegration assistants based on cellulose, preferably in granular, cogranulated or compacted form.

Pure cellulose has the formal empirical composition (C₆H₁₀O₅)ₙ and, viewed in a formal sense, is a β-1,4-polyacetal of cellobiose which is in turn formed from two molecules of glucose. Suitable celluloses consist of from approx. 500 to 5000 glucose units and accordingly have average molar masses of from 50 000 to 500 000. Useful disintegrants based on cellulose in the context of the present invention are also cellulose derivatives which are obtainable by polymer-like reactions from cellulose. Such chemically modified celluloses comprise, for example, products of esterifications and etherifications in which hydroxyl hydrogen atoms have been substituted. However, celluloses in which the hydroxyl groups have been replaced by functional groups which are not bonded via an oxygen atom can also be used as cellulose derivatives. The group of the cellulose derivatives includes, for example, alkali metal celluloses, carboxymethylcelluloses (CMC), cellulose esters and ethers, and amino celluloses.

The cellulose derivatives mentioned are preferably not used alone as disintegrants based on cellulose, but rather in a mixture with cellulose. The content of cellulose derivatives in these mixtures is preferably below 50% by weight, more preferably below 20% by weight, based on the disintegrant based on cellulose. The disintegrant based on cellulose which is used is more preferably pure cellulose which is free of cellulose derivatives. As a further disintegrant based on cellulose or as a constituent of this component, microcrystalline cellulose can be used. This microcrystalline cellulose is obtained by partial hydrolysis of celluloses under such conditions that only the amorphous regions (approx. 30% of the total cellulose mass) of the celluloses are attacked and fully dissolved, but the crystalline regions (approx. 70%) are left undamaged. A subsequent deaggregation of the microfine celluloses formed by the hydrolysis affords the microcrystalline celluloses which have primary particle sizes of approx. 5 μm and can be compacted, for example, to give granules having an average particle size of 200 μm.

In addition to or instead of the disintegration assistants based on cellulose, the inventive products may comprise a gas-releasing system composed of organic acids and carbonates/hydrogencarbonates.

Useful organic acids which release carbon dioxide from the carbonates/hydrogencarbonates in aqueous solution are, for example, the solid mono-, oligo- and polycarboxylic acids. From this group, preference is given in turn to citric acid, tartaric acid, succinic acid, malonic acid, adipic acid, maleic acid, fumaric acid, oxalic acid and polyacrylic acid. Organic sulfonic acids such as amidosulfonic acid can likewise be used. Commercially available and likewise usable with preference as an acidifier in the context of the present invention is Sokalan® DCS (trademark of BASF), a mixture of succinic acid (max. 31% by weight), glutaric acid (max. 50% by weight) and adipic acid (max. 33% by weight).

The acids mentioned do not have to be used stoichiometrically to the carbonates and hydrogencarbonates present in the compacts.

A single- or multiphase detergent tablet which is preferred in the context of the present invention additionally comprises an effervescent system.

The gas-evolving effervescent system consists, in the inventive products, in addition to the organic acids mentioned, of carbonates and/or hydrogencarbonates. Among the representatives of this substance class, there is a distinct preference for the alkali metal salts for reasons of cost. Among the alkali metal carbonates and hydrogencarbonates, there is in turn a distinct preference for the sodium and potassium salts over the other salts for reasons of cost. It will be appreciated that the pure alkali metal carbonates or hydrogencarbonates in question do not have to be used; rather, mixtures of different carbonates and hydrogencarbonates may be preferred.

The electrolytes used from the group of the inorganic salts may be a wide range of highly varying salts. Preferred cations are the alkali metals and alkaline earth metals; preferred anions are the halides and sulfates. From a production point of view, preference is given to the use of NaCl or MgCl₂ in the inventive products.

In order to bring the pH of solutions of the inventive products into the desired range, it may be appropriate to use pH modifiers. It is possible here to use all known acids or alkalis, as long as their use is not forbidden on performance or ecological grounds or on grounds of consumer protection. Typically, the amount of these modifiers does not exceed 1% by weight of the overall formulation. A particularly preferred pH modifier in the context of the present application is citric acid, and it is possible to use citric acid either as a pure substance, for example as the monohydrate, or in the form of coated particles.

The perfume oils or fragrances used may in the context of the present invention be individual odorant compounds, for example the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether, the aldehydes include, for example, the linear alkanals having from 8 to 18 carbon atoms, citral, citronellal, citronellyloxyacet-aldehyde, cyclamen aldehyde, hydroxycitronellal, lilial and bourgeonal, the ketones include, for example, the ionones, α-isomethylionone and methyl cedryl ketone, the alcohols include anethol, citronellol, eugenol, geraniol, linalool, phenylethyl alcohol and terpineol, the hydrocarbons include primarily the terpenes, such as limonene and pinene. However, preference is given to using mixtures of different odorants which are matched to each other in such a way as together to generate a pleasing fragrance note. Such perfume oils may also contain natural odorant mixtures, as obtainable from vegetable sources, e.g. pine oil, citrus oil, jasmine oil, patchouli oil, rose oil and ylang-ylang oil. Likewise suitable are muscatel, sage oil, chamomile oil, oil of cloves, melissa oil, mint oil, cinnamon leaf oil, lime blossom oil, juniperberry oil, vetiver oil, olibanum oil, galbanum oil and labdanum oil, and orange blossom oil, neroliol, orange peel oil and sandalwood oil.

The general description of the perfumes which can be used (see above) is a general representation of the different classes of odorant substances. In order to be perceptible, an odorant must be volatile, for which an important role is played not only by the nature of the functional groups and by the structure of the chemical compound but also by the molar mass. Thus, the majority of odorants have molar masses of up to about 200 daltons, while molar masses of 300 daltons or more tend to be an exception. On the basis of the different volatility of odorants there is a change in the odor of a perfume or fragrance composed of two or more odorants during its evaporation, and the perceived odors are divided into top note, middle note or body, and end note or dryout. Since the perception of odor is to a large extent also based on the odor intensity, the top note of a perfume or fragrance mixture does not consist only of volatile compounds, whereas the base note consists for the most part of less volatile odorants, i.e., odorants which adhere firmly. In the composition of perfumes it is possible for more volatile odorants, for example, to be bound to certain fixatives, which prevent them from evaporating too rapidly. The subsequent classification of the odorants into “more volatile” and “firmly adhering” odorants, therefore, states nothing about the perceived odor and about whether the odorant in question is perceived as a top note or as a middle note.

An appropriate selection of the fragrances and perfume oils mentioned can influence both the odor of the inventive products (product fragrance) and, on completion of the cleaning and care operation, additionally, for example, the odor of the laundry. While more volatile odorants can especially also be used for the influencing of the product fragrance, it is advantageous to use more firmly adhering odorants to achieve an adequate laundry fragrance. Examples of firmly adhering odorants which can be used in the context of the present invention are the essential oils such as angelica root oil, anise oil, arnica blossom oil, basil oil, bay oil, bergamot oil, champaca blossom oil, noble fir oil, noble fir cone oil, elemi oil, eucalyptus oil, fennel oil, spruce needle oil, galbanum oil, geranium oil, ginger grass oil, guaiacwood oil, gurjun balsam oil, helichrysum oil, ho oil, ginger oil, iris oil, cajeput oil, calamus oil, chamomile oil, camphor oil, canaga oil, cardamom oil, cassia oil, pine needle oil, copaiva balsam oil, coriander oil, spearmint oil, caraway oil, cumin oil, lavender oil, lemon grass oil, lime oil, mandarin oil, balm oil, musk seed oil, myrrh oil, clove oil, neroli oil, niaouli oil, olibanum oil, orange oil, origanum oil, palmarosa oil, patchouli oil, Peru balsam oil, petitgrain oil, pepper oil, peppermint oil, pimento oil, pine oil, rose oil, rosemary oil, sandalwood oil, celery oil, spike oil, star anise oil, turpentine oil, thuja oil, thyme oil, verbena oil, vetiver oil, juniperberry oil, wormwood oil, wintergreen oil, ylang-ylang oil, hyssop oil, cinnamon oil, cinnamon leaf oil, citronellol, lemon oil and cypress oil. However, the higher-boiling or solid odorants of natural or synthetic origin may also be used in the context of the present invention as firmly adhering odorants or odorant mixtures, i.e. fragrances. These compounds include the following compounds and mixtures thereof: ambrettolide, α-amylcinnamaldehyde, anethole, anisaldehyde, anisyl alcohol, anisole, methyl anthranilate, acetophenone, benzylacetone, benzaldehyde, ethyl benzoate, benzophenone, benzyl alcohol, benzyl acetate, benzyl benzoate, benzyl formate, benzyl valerate, borneol, bornyl acetate, α-bromostyrene, n-decyl aldehyde, n-dodecylaldehyde, eugenol, eugenol methyl ether, eucalyptol, farnesol, fenchone, fenchyl acetate, geranyl acetate, geranyl formate, heliotropin, methyl heptynecarboxylate, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarin, p-methoxyacetophenone, methyl n-amyl ketone, methyl methylanthranilate, p-methylacetophenone, methylchavicol, p-methylquinoline, methyl β-naphthyl ketone, methyl-n-nonylacetaldehyde, methyl n-nonyl ketone, muscone, β-naphthol ethyl ether, β-naphthol methyl ether, nerol, nitrobenzene, n-nonylaldehyde, nonyl alcohol, n-octylaldehyde, p-oxyacetophenone, pentadecanolide, β-phenylethyl alcohol, phenylacetaldehyde dimethyl acetal, phenylacetic acid, pulegone, safrol, isoamyl salicylate, methyl salicylate, hexyl salicylate, cyclohexyl salicylate, santalol, skatole, terpineol, thymene, thymol, γ-undecalactone, vanillin, veratrum aldehyde, cinnamaldehyde, cinnamyl alcohol, cinnamic acid, ethyl cinnamate, benzyl cinnamate. The more volatile odorants include in particular the lower-boiling odorants of natural or synthetic origin, which may be used alone or in mixtures. Examples of more volatile odorants are alkyl isothiocyanates (alkyl mustard oils), butanedione, limonene, linalool, linalyl acetate and linalyl propionate, menthol, menthone, methyl-n-heptenone, phellandrene, phenylacetaldehyde, terpinyl acetate, citral, citronellal.

In order to improve the esthetic appearance of inventive products, they may comprise dyes. The use of dyes is not restricted to the inventive active phases, but rather may also be in one or all of the further phases in multiphase detergent tablets. In order to avoid repetitions, reference is made at this point to the above remarks on the usable dyes.

Hydrotropes or solubilizers refer to substances which, by their presence, make other compounds which are virtually insoluble in a certain solvent soluble or emulsifiable in this solvent (solubilization). There are solubilizers which enter into a molecular bond with the sparingly soluble substance and those which act by micelle formation. It can also be said that solubilizers actually impart dissolution power to a “latent” solvent. In the case of water as the “latent” solvent, reference is made usually to hydrotropes instead of solubilizers, and in certain cases it is better to refer to emulsifiers.

Useful foam inhibitors which may be used in the inventive products include soaps, oils, fats, paraffins or silicone oils, which may optionally be applied to support materials. Suitable support materials are, for example, inorganic salts such as carbonates or sulfates, cellulose derivatives or silicates and mixtures of the aforementioned materials. Products which are preferred in the context of the present application comprise paraffins, preferably unbranched paraffins (n-paraffins) and/or silicones, preferably linear polymeric silicones which have the composition according to the scheme (R₂SiO)x and are also referred to as silicone oils. These silicone oils are commonly clear, colorless, neutral, odorless, hydrophobic liquids having a molecular weight between 1000-150 000, and viscosities between 10 and 1 000 000 mPa.s.

Suitable antiredeposition agents, which are also referred to as soil repellents, are, for example, nonionic cellulose ethers, such as methylcellulose and methylhydroxypropylcellulose having a proportion of methoxy groups of from 15 to 30% by weight and of hydroxypropyl groups of from 1 to 15% by weight, based in each case on the nonionic cellulose ethers, and the prior art polymers of phthalic acid and/or terephthalic acid or derivatives thereof, in particular polymers of ethylene terephthalates and/or polyethylene glycol terephthalates or anionically and/or nonionically modified derivatives thereof. Of these, particular preference is given to the sulfonated derivatives of phthalic acid polymers and terephthalic acid polymers,

Optical brighteners (known as “whiteners”) may be added to the inventive products in order to eliminate graying and yellowing of the treated textiles. These substances attach to the fibers and bring about brightening and simulated bleaching action by converting invisible ultraviolet radiation to visible longer-wavelength light, in the course of which the ultraviolet light absorbed from sunlight is radiated as pale bluish fluorescence and, together with the yellow shade of the grayed or yellowed laundry, results in pure white. Suitable compounds stem, for example, from the substance classes of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles.

Graying inhibitors have the task of keeping the soil detached from the fiber suspended in the liquor, thus preventing the soil from reattaching. Suitable for this purpose are water-soluble colloids, usually of organic nature, for example the water-soluble salts of polymeric carboxylic acids, size, gelatin, salts of ether sulfonic acids of starch or of cellulose, or salts of acidic sulfuric esters of cellulose or of starch. Water-soluble polyamides containing acidic groups are also suitable for this purpose. In addition, it is possible to use soluble starch preparations, and starch products other than those mentioned above, for example degraded starch, aldehyde starches, etc. It is also possible to use polyvinylpyrrolidone. Also usable as graying inhibitors are cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof.

Since textile fabrics, in particular those made of rayon, viscose, cotton and mixtures thereof, can tend to crease because the individual fibers are sensitive toward bending, folding, compressing and crushing transverse to the fiber direction, the inventive products may comprise synthetic anticrease agents. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters. A substance suitable to a particular degree for textile finishing and care is cottonseed oil which can be produced, for example, by extractively pressing the brown cleaned cottonseeds and refining with about 10% sodium hydroxide or by extracting with hexane at 60-70° C. Such cotton oils contain from 40 to 55% by weight of linoleic acid, from 16 to 26% by weight of oleic acid and from 20 to 26% by weight of palmitic acid. Further particularly preferred products for fiber smoothing and fibercare are the glycerides, especially the monoglycerides of fatty acids, for example glycerol monooleate oder glycerol monostearate.

To control microorganisms, the inventive products may comprise active antimicrobial ingredients. A distinction is drawn here, depending on the antimicrobial spectrum and mechanism of action, between bacteriostats and bactericides, fungistats and fungicides, etc. Important substances from these groups are, for example, benzalkonium chlorides, alkylarylsulfonates, halophenols and phenylmercuric acetate, although it is also possible to dispense entirely with these compounds in the inventive products.

In order to prevent undesired changes, caused by the action of oxygen and other oxidative processes, to the detergents and/or the textiles treated, the inventive products may comprise antioxidants. This class of compound includes, for example, substituted phenols, hydroquinones, pyrocatechols and aromatic amines, and also organic sulfides, polysulfides, dithiocarbamates, phosphites and phosphonates.

Increased wear comfort can result from the additional use of antistats which are additionally added to the inventive products. Antistats increase the surface conductivity and thus permit improved discharge of charges formed. External antistats are generally substances having at least one hydrophilic molecular ligand and impart to the surfaces a more or less hygroscopic film. These usually interface-active antistats can be subdivided into nitrogen antistats (amines, amides, quaternary ammonium compounds), phosphorus antistats (phosphoric esters) and sulfur antistats (alkylsulfonates, alkyl sulfates). Lauryl- (or stearyl)dimethylbenzylammonium chlorides are likewise suitable as antistats for textiles or as additives for detergents, in which case a softening effect is additionally achieved.

Repellency and impregnation processes serve to finish textiles with substances which prevent the deposition of soil or make it easier to wash out. Preferred repellents and impregnating agents are perfluorinated fatty acids, also in the form of their aluminum and zirconium salts, organic silicates, silicones, polyacrylic esters having a perfluorinated alcohol component or polymerizable compounds having a coupled, perfluorinated acyl or sulfonyl radical. Antistats may also be present. The soil-repellent finish with repellents and impregnating agents is often classified as an easycare finish. The penetration of the impregnating agents in the form of solutions or emulsions of the active ingredients in question may be eased by adding wetting agents which lower the surface tension. A further field of use of repellents and impregnating agents is the water-repellent finishing of textiles, tents, tarpaulins, leather, etc., in which, in contrast to waterproofing, the fabric pores are not sealed and the substance thus remains breathable (hydrophobicizing). The hydrophobicizing agents used for the hydrophobicization coat textiles, leather, paper, wood, etc., with a very thin layer of hydrophobic groups such as relatively long alkyl chains or siloxane groups. Suitable hydrophobicizing agents are, for example, paraffins, waxes, metal soaps, etc., with additives of aluminum or zirconium salts, quaternary ammonium compounds having long-chain alkyl radicals, urea derivatives, fatty acid-modified melamine resins, chromium complex salts, silicones, organotin compounds and glutaraldehyde, and also perfluorinated compounds. The hydrophobicized materials do not have a greasy feel, but water drops, similarly to the way they do on greased substances, run off them without wetting them. For example, silicone-impregnated textiles have a soft hand and are water- and soil-repellant. Stains of ink, wine, fruit juices and the like can be removed more easily.

The nonaqueous solvents which can be used in the inventive products include in particular the organic solvents, of which only the most important can be listed here: alcohols (methanol, ethanol, propanols, butanols, octanols, cyclohexanol), glycols (ethylene glycol, diethylene glycol), ethers and glycol ethers (diethyl ether, dibutyl ether, anisole, dioxane, tetrahydrofuran, mono-, di-, tri-, polyethylene glycol ethers), ketones (acetone, butanone, cyclohexanone), esters (ethyl acetate, glycol esters), amides including nitrogen compounds (dimethylformamide, pyridine, N-methylpyrrolidone, acetonitrile), sulfur compounds (carbon disulfide, dimethyl sulfoxide, sulfolane), nitro compounds (nitrobenzene), halohydrocarbons (dichloromethane, chloroform, tetrachloromethane, tri-, tetrachloroethene, 1,2-dichloroethane, chlorofluorocarbons), hydrocarbons (benzine, petroleum ether, cyclohexane, methylcyclohexane, decalin, terpene solvents, benzene, toluene, xylenes). Alternatively, it is also possible instead of the pure solvents to use mixtures thereof which, for example, advantageously combine the dissolution properties of different solvents. Such a solvent mixture which is particularly preferred in the context of the present application is, for example, petroleum benzine, a mixture, suitable for chemical purification, of different hydrocarbons, preferably having a content of C12 to C14 hydrocarbons above 60% by weight, more preferably above 80% by weight and in particular above 90% by weight, based in each case on the total weight of the mixture, preferably having a boiling range of from 81 to 110° C.

For the care of the textiles and for an improvement in the textile properties such as a softer “hand” (softening) and reduced electrostatic charge (increased wear comfort), the inventive products may comprise fabric softeners. The active ingredients in fabric softener formulations are ester quats, quaternary ammonium compounds having two hydrophobic radicals, for example distearyldimethylammonium chloride which, however, owing to its inadequate biodegradability, is increasingly being replaced by quaternary ammonium compounds which contain ester groups in their hydrophobic radicals as intended cleavage sites for biodegradation. Such ester quats having improved biodegradability are obtainable, for example, by esterifying mixtures of methyldiethanolamine and/or triethanolamine with fatty acids and subsequently quaternizing the reaction products with alkylating agents in a manner known per se. Another suitable finish is dimethylolethyleneurea.

To improve the water-absorption capacity, the rewettability of the textiles treated with inventive products having active phase and to ease the ironing of these textiles, it is possible to use silicone derivatives, for example, in the inventive products. They additionally improve the rinse-out performance of the inventive products by virtue of their foam-inhibiting properties. Preferred silicone derivatives are, for example, polydialkyl- or alkylarylsiloxanes in which the alkyl groups have from 1 to 5 carbon atoms and are fully or partly fluorinated. Preferred silicones are polydimethylsiloxanes which may optionally be derivatized and are in that case amino-functional or quaternized or have Si—OH, Si—H and/or Si—Cl bonds. Further preferred silicones are the polyalkylene oxide-modified polysiloxanes, i.e. polysiloxanes which have polyethylene glycols, for example, and the polyalkylene oxide-modified dimethyl polysiloxanes.

Owing to their fibercare action, protein hydrolyzates are further preferred active substances from the field of detergents in the context of the present invention. Protein hydrolyzates are product mixtures which are obtained by acid-, base- or enzyme-catalyzed degradation of proteins. According to the invention, protein hydrolyzates either of vegetable or animal origin may be used. Animal protein hydrolyzates are, for example, elastin, collagen, keratin, silk and milk protein hydrolyzates which may also be present in the form of salts. Preference is given in accordance with the invention to the use of protein hydrolyzates of vegetable origin, for example soya, almond, rice, pea, potato and wheat protein hydrolyzates. Although preference is given to the use of the protein hydrolyzates as such, it is in some cases also possible to use in their stead amino acid mixtures or individual amino acids obtained in other ways, for example arginine, lysine, histidine or pyroglutamic acid. It is likewise possible to use derivatives of protein hydrolyzates, for example in the form of their fatty acid condensates.

Finally, the inventive products may also comprise UV absorbers which attach to the treated textiles and improve the photoresistance of the fibers. Compounds which have these desired properties are, for example, the compounds and derivatives of benzophenone having substituents in the 2- and/or 4-position which are active by virtue of radiationless deactivation. Also suitable are substituted benzotriazoles, 3-phenyl-substituted acrylates (cinnamic acid derivatives), optionally having cyano groups in the 2-position, salicylates, organic Ni complexes and natural substances such as umbelliferone and endogenous urocanic acid.

To protect the ware or the machine, detergents for machine dishwashing may comprise corrosion inhibitors, and in particular silver protectants and glass corrosion inhibitors have special significance in the field of machine dishwashing. It is possible to use the known prior art substances. In general, it is possible in particular to use silver protectants selected from the group of the triazoles, the benzotriazoles, the bisbenzotriazoles, the aminotriazoles, the alkylamino-triazoles and the transition metal salts or complexes. Particular preference is given to using benzotriazole and/or alkylaminotriazole. Additionally found in cleaning formulations are frequently active chlorine-containing agents which can distinctly reduce the corrosion of the silver surface. In chlorine-free cleaners, particularly oxygen- and nitrogen-containing organic redox-active compounds are used, such as di-and trivalent phenols, e.g. hydroquinone, pyrocatechol, hydroxyhydroquinone, gallic acid, phloroglucine, pyrogallol or derivatives of these compound classes. Salt- and complex-type inorganic compounds such as salts of the metals Mn, Ti, Zr, Hf, V, Co and Ce frequently also find use. Preference is given here to the transition metal salts which are selected from the group of the manganese and/or cobalt salts and/or complexes, more preferably the cobalt (ammine) complexes, the cobalt (acetate) complexes, the cobalt (carbonyl) complexes, the chlorides of cobalt or manganese and of manganese sulfate, and the manganese complexes
[(Me-TACN)Mn^{IV}(m-O)₃Mn^{IV}(Me-TACN)]²⁺(PF₆⁻)₂,
[(Me-MeTACN)Mn^{IV}(m-O)₃Mn^{IV}(Me-MeTACN)]²⁺(PF₆⁻)₂,
[(Me-TACN)Mn^{III}(m-O)(m-OAc)₂Mn^{III}(Me-TACN)]²⁺(PF₆⁻)₂ and
[(Me-MeTACN)Mn^{III}(m-O)(m-OAc)₂Mn^{III}(Me-MeTACN)]²⁺(PF₆⁻)₂,
where Me-TACN is 1,4,7-trimethyl-1,4,7-triazacyclononane and Me-MeTACN is 1,2,4,7-tetramethyl-1,4,7-tri-azacyclononane. It is likewise possible to use zinc compounds to prevent corrosion of the ware.

In the context of the present invention, preference is given to using at least one silver protectant selected from the group of the triazoles, the benzotriazoles, the bisbenzotriazoles, the aminotriazoles, the alkylaminotriazoles, preferably benzotriazole and/or alkylaminotriazole.

In addition to the aforementioned silver protectants, inventive products may further comprise one or more substances for reducing glass corrosion. In the context of the present application, preference is given especially to additives of zinc and/or inorganic and/or organic zinc salts and/or silicates, for example the sheet-type crystalline sodium disilicate SKS 6 from Clariant GmbH, and/or water-soluble glasses, for example glasses which have a mass loss of at least 0.5 mg under the conditions specified in DIN ISO 719 for the reduction of glass corrosion. Particularly preferred products comprise at least one zinc salt of an organic acid, preferably selected from the group of zinc oleate, zinc stearate, zinc gluconate, zinc acetate, zinc lactate and zinc citrate.

As explained at the outset of this description, it is an object of the present application to provide a detergent tablet which is suitable for the incorporation and optimized release of additives, especially of additives having a low proportion by weight in the overall formulation of the detergent tablets. While all aforementioned washing and/or cleaning substances may generally also be used as active substances in the active phase of inventive detergent tablets, it has been found in the context of the present application that the incorporation, especially the incorporation of washing or cleaning substances from the group of the enzymes, glass corrosion inhibitors, silver protectants, film-inhibiting polymers and pH modifiers and mixtures thereof is particularly advantageous.

The present application therefore further preferably provides detergent tablets, characterized in that the washing or cleaning substances enclosed by the solid matrix are selected from the group of the enzymes and/or the glass corrosion inhibitors and/or the silver protectants and/or the film-inhibiting polymers and/or the pH modifiers.

Particularly preferred mixtures of active substances are in particular mixtures of glass corrosion inhibitor and silver protectant, of glass corrosion inhibitor and film-inhibiting polymer(s), of silver protectant and film-inhibiting polymer(s) or of glass corrosion inhibitor, silver protectant and scale-inhibiting polymer(s).

When glass corrosion inhibitors or silver protectants or film-inhibiting polymers or their aforementioned particularly preferred mixtures are used in the active phases of inventive detergent tablets, the proportion by weight of these washing or cleaning substances in the total weight of the active phase is preferably from 2 to 40% by weight, more preferably from 3 to 30% by weight and in particular from 4 to 25% by weight.

Inventive detergent tablets may have one or more phases. Single-phase detergent tablets in the context of the present application are, for example, tablets which have only one active phase in which the active substance(s) present is/are in homogeneous distribution. As described at the outset, such tablets can be produced, for example, by solidifying an active substance-containing melt.

However, inventive active phases are also suitable for the incorporation of washing and/or cleaning substances incorporated for shaping purposes. For example, it is also possible to incorporate into the inventive active phases crystals, powders, granules, extrudates, compactates or castings which comprise washing and/or cleaning substances. Preference is therefore given in the context of the present application to detergent tablets which comprise the washing or cleaning substances in the matrix enclosing them in preincorporated form, preferably as crystal(s) and/or powder and/or granule(s) and/or extrudate(s) and/or compactate(s) and/or castings. Owing to their advantageous appearance, especially in combination with transparent active phases, particular preference is given to crystals and/or tablets as an incorporation form for the washing and/or cleaning substances present in the active phase. The tablets which can be used range from “minitabs” having a weight in the range from 50 to 500 mg, preferably from 100 to 250 mg, up to tablets having a weight above 1 g, preferably above 5 g. In the case of tablets formulated in this way, the active phase surrounding them not only improves their appearance and release profile, but also increases their fracture stability. Therefore generally be tableted at reduced stamp pressures compared to the production of commercial detergent tablets and, in addition to improved disintegration properties, also have correspondingly reduced fracture hardnesses, but a distinction has to be drawn with regard to these tablets having reduced fracture hardnesses between detergent tablets for machine dishwashing and textile detergent tablets. The present application therefore preferably provides tablets for textile cleaning, characterized in that the washing or cleaning substances for textile cleaning are present in tableted form in the matrix which encloses them and this/these tablet(s) preferably has/have a fracture hardness below 30 N, more preferably below 25 N and in particular below 20 N. The present application further preferably provides detergent tablets for machine dishwashing, characterized in that the washing or cleaning substances for machine dishwashing are present in tableted form in the matrix which encloses them and this/these tablet(s) preferably has/have a fracture hardness below 100 N, more preferably below 85 N and in particular below 70 N. (The tablet hardness is determined by exerting a force on the side surfaces of the tablet until the tablet fractures and determinining of the maximum force that the tablet withstands.)

The inventive detergent tablets are especially suitable, as explained in the introduction, for the incorporation of combination products which, in addition to the customary constituents of detergents, also comprise one or more additives, especially from the group of the enzymes and/or the glass corrosion inhibitors and/or the silver protectants and/or the film-inhibiting polymers and/or the pH modifiers.

Such tablets can be produced by all processes known to those skilled in the art. However, preference is given to integrating inventive active phases subsequently into this basic structure after the production of a detergent basic structure. The basic structure is produced preferably by tableting and/or casting and/or extrusion, but preferably by tableting and/or casting.

In principle, particularly suitable basic structures for the uptake of the active phase are those which enable, after the integration of the active phase, the presentation of the active phase on the surface of the resulting detergent tablet, since this method ensures both an advantageous dissolution profile and an advantageous appearance. In the context of the present application, preferred detergent tablets are characterized in that the phase which consists of one or more washing and/or cleaning substance(s) enclosed by a solid matrix makes up at least 5%, preferably at least 7.5% and in particular at least 10% of the total surface area of the detergent tablet, and, in a further preferred embodiment, the quotient of the proportion by weight of the active phase in the total weight of the detergent tablet and the proportion of the active phase in the total surface area of the detergent tablet is at least 0.1, preferably at least 0.2, more preferably at least 0.4 and in particular at least 1.0; in other words, the active phase takes up a disproportionately large proportion of the surface area of such detergent tablets in comparison to its proportion by weight.

One example of the aforementioned basic structures is that of depression tablets producible by tableting, in whose depression the active phase can be incorporated by a series of different processes. For example, the depression can be filled by casting a melt or a solution of the matrix material therein. Subsequent solidification then results in the inventive detergent tablet having active phase. The washing and/or cleaning substances may, in such a process, for example, as desired, be a) present in the melt or solution of the matrix material, b) introduced into the depression in particulate form before the melt or solution is introduced and optionally adhesive-bonded in the depression before the melt or solution is introduced or c) metered in particulate form into the melt or solution after the melt or solution of the matrix material has been introduced into the depression but before it has solidified. Suitable active substance particles are in particular the aforementioned crystals, powders, granules, extrudates, compactates and castings. A further means of incorporating the active phase into inventive tablets consists in the production of prefabricated active phases by introducing the matrix material melt or solution into casting molds and subsequently allowing it to set. Prefabricated active phases produced in this way may subsequently be removed from the casting molds and inserted into the depressions. The active phases can be secured in the depressions, for example, by adhesive bonding. When a basic structure which does not have a depression is used in the aforementioned process, it is also possible for a prefabricated active phase to be secured to a planar surface of this tablet by adhesive bonding.

The present application preferably further provides detergent tablets, characterized in that the single- or multiphase detergent tablet has a depression which encloses the active phase at least partly, and also detergent tablets, characterized in that the detergent tablet has a planar outer surface to which the active phase which partly covers the planar outer surface adheres.

Preference is further given to single- or multiphase detergent tablets which comprise the active phase in the form of a layer.

The inventive single- or multiphase detergent tablets may be offered to the consumer in conventional containers made of all customary water-insoluble casing materials which are well known to those skilled in the art in this field. Preferred polymers include in particular hydrocarbon-based polymers. The particularly preferred polymers include polyethylene, polypropylene (more preferably oriented polypropylene) and polymer mixtures, for example mixtures of the polymers mentioned with polyethylene terephthalate. Also useful are one or more polymers from the group of polyvinyl chloride, polysulfones, polyacetals, water-insoluble cellulose derivatives, cellulose acetate, cellulose propionate, cellulose acetobutyrate and mixtures of the polymers mentioned or the copolymers including the polymers mentioned.

However, a particularly preferred embodiment of the present invention has for its object to provide to the consumer inventive products which have a water-soluble casing which the consumer can insert without further handling steps directly, i.e. with the casing, for example, into the washing machine or into the dishwasher. Such casings include water-soluble or -decomposible casings such as pouches made of water-soluble film, pouches or other casings made of water-soluble or -decomposible nonwovens or else flexible or rigid structures made of water-soluble polymers, preferably in the form of filled cavities which can be produced, for example, by thermoforming, injection molding, blow molding, calendering, etc.

The present invention therefore further provides inventive single- or multiphase detergent tablets which have a water-soluble casing.

Inventive tablets preferably have a fully or partly water-soluble casing. The shape of the casing is not restricted to certain shapes. In principle, useful shapes of the casing are all Archimedean and Platonic structures, i.e. three-dimensional tablets. Examples of the shape of the casing are capsules, cubes, spheres, ovoid tablets, cuboids, cones, rods or pouches. Hollow structures having one or more compartments are also suitable as a casing for the inventive products. In preferred embodiments of the invention, the casings have the shape of capsules, as are also used, for example, in pharmacy for administering drugs, of spheres or of pouches. The latter are preferably fused or adhesive-bonded at at least one side, and the adhesive in particularly preferred embodiments of the invention is a water-soluble adhesive.

The exact shape of a preferred water-soluble casing for inventive products is not critical and can be adapted substantially to the circumstances of use. It is possible to use, for example, processed plastics films or plaques worked to different shapes (such as tubes, cushions, cylinders, bottles, sheets, or the like), capsules and other conceivable shapes. Particular preference is given in accordance with the invention to films which can be adhesive-bonded and/or sealed, for example, to give casings such as tubes, cushions, and the like, after they have been filled with individual inventive tablets or a plurality thereof.

Owing to the outstanding properties adaptable to the desired physical conditions, preference is further given in accordance with the invention to plastics film casings made of water-soluble polymer materials. Such films are known in principle from the prior art.

In summary, preferred casings for inventive tablets are both hollow structures of any shape which can be produced by injection molding, bottle blowing, thermoforming, etc., and hollow structures made of films, especially pouches. Preferred inventive tablets are thus characterized in that the water-soluble casing comprises a pouch made of water-soluble film and/or an injection molding and/or a blow molding and/or a thermoformed part.

Preference is given in accordance with the invention to the water-soluble casing being sealed. This brings the advantage that the products are protected optimally against environmental influences, especially against moisture.

Useful materials for the fully or partly water-soluble casing are in principle all materials which can fully or partly dissolve in the aqueous phase under the given conditions of a wash operation, rinse operation or cleaning operation (temperature, pH, concentration of washing components). The polymer materials may more preferably belong to the groups of (optionally partly acetalized) polyvinyl alcohol, polyvinylpyrrolidone, polyethylene oxide, gelatin, cellulose and derivatives thereof, starch and derivatives thereof, especially modified starches, and mixtures (polymer blends, composites, coextrudates, etc.) of the materials mentioned. Particular preference is given to gelatin and polyvinyl alcohols, and the two materials mentioned, each in a composite with starch or modified starch. Also useful as materials for the at least partly water-soluble casing are inorganic salts and mixtures thereof.

Preferred inventive products are characterized in that the casing comprises one or more materials from the group of acrylic acid-containing polymers, polyacrylamides, oxazoline polymers polystyrenesulfonates, polyurethanes, polyesters and polyethers, and mixtures thereof.

Particularly preferred inventive products are characterized in that the casing comprises one or more water-soluble polymer(s), preferably a material from the group of (optionally acetalized) polyvinyl alcohol (PVAL), polyvinylpyrrolidone, polyethylene oxide, gelatin, cellulose, and the derivatives and mixtures thereof, more preferably (optionally acetalized) polyvinyl alcohol (PVAL).

“Polyvinyl alcohols” (abbreviation PVAL, sometimes also PVOH) is the designation for polymers of the general structure 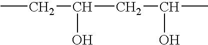
which also contain structural units of the 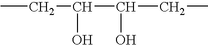
type in small amounts (approx. 2%).

Commercial polyvinyl alcohols, which are supplied as white-yellowish powders or granules having degrees of polymerization in the range from approx. 100 to 2500 (molar masses from approx. 4000 to 100 000 g/mol), have degrees of hydrolysis of 98-99 or 87-89 mol % and thus also contain a residual content of acetyl groups. The polyvinyl alcohols are characterized on the part of the manufacturers by specifying the degree of polymerization of the starting polymer, the degree of hydrolysis, the hydrolysis number and the solution viscosity.

Depending on the degree of hydrolysis, polyvinyl alcohols are soluble in water and less polar organic solvents (formamide, dimethylformamide, dimethyl sulfoxide); they are not attacked by (chlorinated) hydrocarbons, esters, fats and oils. Polyvinyl alcohols are classified as being toxicologically uncontroversial and are at least partly biodegradable. The solubility in water can be reduced by after treatment with aldehydes (acetalization), by complexation with nickel or copper salts or by treatment with dichromates, boric acid or borax. The coatings made of polyvinyl alcohol are substantially impenetrable to gases such as oxygen, nitrogen, helium, hydrogen, carbon dioxide, but allow water vapor to pass through.

In the context of the present invention, it is preferred that the casing comprises a polyvinyl alcohol whose degree of hydrolysis is from 70 to 100 mol %, preferably from 80 to 90 mol %, more preferably from 81 to 89 mol % and in particular from 82 to 88 mol %.

The materials which are used for the casing are preferably polyvinyl alcohols of a certain molecular weight range, and it is preferred in accordance with the invention for the casing to comprise a polyvinyl alcohol whose molecular weight is in the range from 10 000 to 100 000 gmol⁻¹, preferably from 11 000 to 90 000 gmol⁻¹, more preferably from 12 000 to 80 000 gmol⁻¹ and in particular from 13 000 to 70 000 gmol⁻¹.

The degree of polymerization of such preferred polyvinyl alcohols is between about 200 and about 2100, preferably between about 220 and about 1890, more preferably between about 240 and about 1680 and in particular between about 260 and about 1500.

The above-described polyvinyl alcohols are commercially widely available, for example under the trademark Mowiol® (Clariant). Polyvinyl alcohols which are particularly suitable in the context of the present invention are, for example, Mowiol® 3-83, Mowiol® 4-88, Mowiol® 5-88 and Mowiol® 8-88.

Further polyvinyl alcohols which are particularly suitable as material for the casing can be taken from the table below:

| | Degree of | | |
|---|---|---|---|
| | hydrolysis | Molar mass | Melting |
| Name | [%] | [kDa] | point [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Further polyvinyl alcohols suitable as material for the casing are ELVANOL® 51-05, 52-22, 50-42, 85-82, 75-15, T-25, T-66, 90-50 (trademark of Du Pont), ALCOTEX® 72.5, 78, B72, F80/40, F88/4, F88/26, F88/40, F88/47 (trademark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trademark of Nippon Gohsei K.K.).

The water-solubility of PVAL can be altered by aftertreatment with aldehydes (acetalization) or ketones (ketalization). It has been found that polyvinyl alcohols which are particularly preferred and particularly advantageous owing to their outstandingly good cold-water solubility are those which are acetalized or ketalized with the aldehyde or keto groups, respectively, of saccharides or polysaccharides or mixtures thereof. It has been found to be extremely advantageous to use the reaction products of PVAL and starch.

In addition, the water-solubility can be altered by complexation with nickel or copper salts or by treatment with dichromates, boric acid, borax and thus be adjusted to desired values in a controlled manner. Films made of PVAL are substantially impenetrable to gases such as oxygen, nitrogen, helium, hydrogen, carbon dioxide, but allow water vapor to pass through.

Examples of suitable water-soluble PVAL films are the PVAL films obtainable under the name “SOLUBLON®” from Syntana Handelsgesellschaft E. Harke GmbH & Co. Their solubility in water can be adjusted to a precise degree and films of this product series are available which are soluble in the aqueous phase in all temperature ranges relevant to the application.

Polyvinylpyrrolidones, referred to as PVPs for short, can be described by the following general formula:

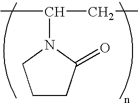

PVPs are prepared by free-radical polymerization of 1-vinylpyrrolidone. Commercial PVPs have molar masses in the range from about 2500 to 750 000 g/mol and are supplied as white, hygroscopic powders or as aqueous solutions.

Polyethylene oxides, PEOXs for short, are polyalkylene glycols of the general formula
H—[O—CH₂—CH₂]ₙ—OH
which are prepared industrially by base-catalyzed polyaddition of ethylene oxide (oxirane) in systems comprising usually small amounts of water with ethylene glycol as the starter molecule. They have molar masses in the range from approx, 200 to 5 000 000 g/mol, corresponding to degrees of polymerization n of from approx. 5 to >100 000. Polyethylene oxides have an extremely low concentration of reactive hydroxyl end groups and exhibit only weak glycol properties.

Gelatin is a polypeptide (molar mass: approx. 15 000 to >250 000 g/mol) which is obtained principally by hydrolysis of the collagen present in animal skin and bones under acidic or alkaline conditions. The amino acid composition of the gelatin corresponds substantially to that of the collagen from which it has been obtained and varies depending on its provenance. The use of gelatin as the water-soluble shell material in the form of hard or soft gelatin capsules is extremely widespread, especially in pharmacy. Gelatin is not used widely in the form of films due to its high cost compared to the aforementioned polymers.

In the context of the present invention, preference is also given to inventive products whose casing consists at least partly of water-soluble film composed of at least one polymer from the group of starch and starch derivatives, cellulose and cellulose derivatives, especially methylcellulose and mixtures thereof.

Starch is a homoglycan, and the glucose units have α-glycosidic linkages. Starch is made up of two components of different molecular weight: from approx. 20 to 30% of straight-chain amylose (MW from about 50 000 to 150 000) and from 70 to 80% of branched-chain amylopectin (MW from approx. 300 000 to 2 000 000). In addition, small amounts of lipids, phosphoric acid and cations are also present. While the amylose forms long, helical, intertwined chains having from approx. 300 to 1200 glucose molecules owing to the 1,4-bonding, the chain in the case of amylopectin branches after an average of 25 glucose building blocks as a result of 1,6-bonding to give a branchlike structure having from approx. 1500 to 12 000 glucose molecules. In addition to pure starch, suitable in the context of the present invention for the preparation of water-soluble casings of the detergent and rinse aid portions are also starch derivatives which are obtainable from starch by polymer-like reactions. Such chemically modified starches include, for example, products of esterifications or etherifications in which hydroxyl hydrogen atoms have been substituted. However, starches in which the hydroxyl groups have been replaced by functional groups which are not bonded via an oxygen atom can also be used as starch derivatives. The group of starch derivatives includes, for example, alkali metal starches, carboxymethylstarch (CMS), starch esters and ethers, and aminostarches.

Pure cellulose has the formal empirical composition (C₆H₁₀O₅)ₙ and, viewed in a formal sense, is a β-1,4-polyacetal of cellobiose which is itself formed from two molecules of glucose. Suitable celluloses consist of from approx. 500 to 5000 glucose units and accordingly have average molar masses of from 50 000 to 500 000. Usable cellulose-based disintegrants in the context of the present invention are also cellulose derivatives which are obtainable from cellulose by polymer-like reactions. Such chemically modified celluloses include, for example, products from esterifications and etherifications in which hydroxyl hydrogen atoms have been substituted. However, celluloses in which the hydroxyl groups have been replaced by functional groups not attached via an oxygen atom may also be used as cellulose derivatives. The group of cellulose derivatives includes, for example, alkali metal celluloses, carboxymethylcellulose (CMC), cellulose esters and ethers, and aminocelluloses.

Preferred casings made of at least partially water-soluble film comprise at least one polymer with a molar mass between 5000 and 500 000 g/mol, preferably between 7500 and 250 000 g/mol and in particular between 10 000 and 100 000 g/mol. The casing has different material thicknesses depending on the production process, and preference is given to inventive machine dishwasher detergents in which the wall thickness of the casing is from 10 to 5000 μm, preferably from 20 to 3000 μm, more preferably from 25 to 2000 μm and in particular from 100 to 1500 μm.

When film pouches are selected as the casing, the water-soluble film which forms the casing preferably has a thickness of from 1 to 300 μm, preferably from 2 to 200 μm, more preferably from 5 to 150 μm and in particular from 10 to 100 μm.

These water-soluble films can be produced by various production processes. In principle, mention should be made here of blowing, calendering and casting processes. In a preferred process, the films are blown starting from a melt with air through a blowing mandrel to give a tube. In the calendering process, which is likewise one of the preferred production processes, the raw materials plasticized by suitable additives are atomized to form the films. It may in particular be necessary here to follow the atomizations with a drying step. In the casting process, which is likewise one of the preferred production processes, an aqueous polymer preparation is placed onto a heatable drying roll and is optionally cooled after evaporation of the water, and the film is drawn off. Where necessary, this sheet is additionally powdered before being or while being drawn off.

Preference is given in accordance with the invention to an embodiment in which the entire casing is water-soluble, i.e. dissolves completely when used as intended for machine dishwashing when the conditions envisaged for dissolution are attained. Particularly preferred fully water-soluble casings are, for example, capsules made of gelatin, advantageously made of soft gelatin, or pouches made of (optionally partially acetalized) PVAL or spheres made of gelatin or (optionally partially acetalized) PVAL or of one or more organic and/or inorganic salts, preferably spheres made of soft gelatin. A significant advantage of this embodiment is that the casing at least partially dissolves within a practically relevant short time—as a nonlimiting example a few seconds to 5 min can be specified—under precisely defined conditions in the cleaning liquor and thus, in accordance with the requirements, introduce the encased content, i.e. the inventive single- or multiphase detergent tablet, into the liquor.

In another embodiment of the invention which is likewise preferred owing to advantageous properties, the water-soluble casing includes regions which are less readily water-soluble or even water-insoluble or are water-soluble only at elevated temperature, and regions which are readily water-soluble or water-soluble at low temperature. In other words, the casing consists not only of one uniform material having the same water solubility in all regions, but rather of materials of different water solubility. In this connection, a distinction is to be drawn firstly between regions of good water solubility and regions with less good water solubility, with poor or even zero water solubility, and secondly regions in which the water solubility attains the desired value only at elevated temperature or only at a different pH or only at an altered electrolyte concentration. This may lead, when the product is used as intended under adjustable conditions, to certain regions of the casing dissolving, while other areas remain intact. For instance a casing provided with pores or holes forms, into which water and/or liquor can penetrate, dissolve washing, rinsing or cleaning ingredients and flush them out of the casing. In the same way, casing systems in the form of multichamber pouches or in the form of hollow structures arranged inside one another (e.g. spheres: “onion system”) can also be provided. In this way, systems with controlled release of the washing, rinsing or cleaning ingredients can be prepared.

For the formation of such systems, the invention is not subject to any restrictions. For instance, casings can be provided in which a uniform polymer material includes small regions of incorporated compounds (for example of salts) which are more rapidly water-soluble than the polymer material. On the other hand, a plurality of polymer materials with different water solubility can also be mixed (polymer blend), so that the polymer material which dissolves more quickly is more rapidly disintegrated under defined conditions by water or the liquor than the material which dissolves more slowly.

In a particularly preferred embodiment of the invention, the regions of the casing which are less readily water-soluble or regions which are completely water-insoluble or regions which are water-soluble only at elevated temperature are regions made of a material which chemically substantially corresponds to that of the readily water-soluble regions or regions which are water-soluble at a lower temperature, but has a higher layer thickness and/or has an altered degree of polymerization of the same polymer and/or has a higher degree of crosslinking of the same polymer structure and/or has a higher degree of acetalization (in the case of PVAL, for example, with saccharides, polysaccharides such as starch) and/or has a content of water-insoluble salt components and/or has a content of a water-insoluble polymer. Even taking into account the fact that the casing does not dissolve fully, detergent portions according to the invention can be provided which have advantageous properties in the release of the dishwasher detergents into the particular liquor. In addition to the controlled release of selected washing and/or cleaning substances by the active phase, the preferred inventive products equipped with such a casing thus offer a second regulatory feature for the controlled release of active substances.

The water-soluble shell material is preferably transparent. In the context of this invention, transparency means that the transmittance within the visible spectrum of light (410 to 800 nm) is greater than 20%, preferably greater than 30%, extremely preferably greater than 40% and especially greater than 50%. Thus, as soon as one wavelength of the visible spectrum of light has a transmittance greater than 20%, it should be considered as transparent in the context of the invention.

Inventive products which are packaged in transparent casings or containers may comprise a stabilizer as an essential constituent. In the context of the invention, stabilizers are materials which protect the detergent constituents in their water-soluble, transparent casings from decomposition or deactivation as a result of light irradiation. It has been found that antioxidants, UV absorbers and fluorescent dyes are particularly suitable here.

In the context of the invention, particularly suitable stabilizers are the antioxidants. In order to prevent undesired changes to the formulations caused by light irradiation and thus free-radical decomposition, the formulations may comprise antioxidants. The antioxidants used may be, for example, phenols, bisphenols and thiobisphenols substituted by sterically hindered groups. Further examples are propyl gallate, butylhydroxytoluene (BHT), butylhydroxyanisole (BHA), t-butylhydroquinone (TBHQ), tocopherol and the long-chain (C8-C22) esters of gallic acid, such as dodecyl gallate. Other substance classes are aromatic amines, preferably secondary aromatic amines and substituted p-phenylenediamines, phosphorus compounds with trivalent phosphorus, such as phosphines, phosphites and phosphonites, citric acids and citric acid derivatives such as isopropyl citrate, compounds containing enediol groups, known as reductones, such as ascorbic acid and derivatives thereof such as ascorbic acid palmitate, organosulfur compounds such as the esters of 3,3′-thiodipropionic acid with C₁₋₁₈-alkanols, especially C₁₀₋₁₈-alkanols, metal ion deactivators which are capable of complexing the autoxidation-catalyzing metal ions, for example copper, such as nitrilotriacetic acid, and derivatives and mixtures thereof. Antioxidants may be present in the formulations in amounts up to 35% by weight, preferably up to 25% by weight, more preferably from 0.01 to 20% by weight and in particular from 0.03 to 20% by weight.

A further class of stabilizers which can be used with preference is that of the UV absorbers. UV absorbers can improve the photostability of the formulation constituents. They include organic substances (light protection filters) which are capable of absorbing ultraviolet rays and emitting the energy absorbed again in the form of longer-wavelength radiation, for example heat. Compounds which have these desired properties are, for example, the compounds and derivatives of benzophenone having substituents in the 2- and/or 4-position which are effective by virtue of radiationless deactivation. Also suitable are substituted benzotriazoles, such as, for example, the water-soluble monosodium 3-(2H-benzotriazol-2-yl)-4-hydroxy-5-(methylpropyl)benzenesulfonate (Cibafast® H), 3-phenyl-substituted acrylates (cinnamic acid derivatives), optionally having cyano groups in the 2-position, salicylates, organic nickel complexes and natural substances such as umbelliferone and endogenous urocanic acid. Of particular significance are biphenyl and in particular stilbene derivatives which are available commercially as Tinosorb® FD or Tinosorb® FR ex Ciba. UV-B absorbers include 3-benzylidenecamphor or 3-benzylidenenorcamphor and derivatives thereof, for example 3-(4-methylbenzylidene)camphor; 4-aminobenzoic acid derivatives, preferably 2-ethylhexyl 4-(dimethyl-amino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives, for example 2,4,6-trianilino(p-carbo-2′-ethyl-1′-hexyloxy)-1,3,5-triazine and octyl triazone or dioctylbutamidotriazone (Uvasorb® HEB); propane-1,3-diones, for example 1-(4-tert-butylphenyl)-3-(4′-methoxyphenyl)propane-1,3-dione; ketotricyclo-(5.2.1.0)decane derivatives. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, for example 4-(2-oxo-3-bornylidenemethyl)benzenesulfonic acid and 2-methyl-5-(2-oxo-3-bornylidene)sulfonic acid and salts thereof.

Useful typical UV-A filters are in particular derivatives of benzoylmethane, for example 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds. The UV-A and UV-B filters can of course also be used in mixtures. In addition to the soluble substances mentioned, insoluble light protection pigments are also suitable for this purpose, specifically finely dispersed, preferably nanoized, metal oxides or salts. Examples of suitable metal oxides are in particular zinc oxide and titanium dioxide and additionally oxides of iron, zirconium, silicon, manganese, aluminum and cerium, and mixtures thereof. The salts used may be silicates (talc), barium sulfate or zinc stearate. The oxides and salts are already used in the form of pigments for skincare and skin-protecting emulsions and decorative cosmetics. The particles should have an average diameter of less than 100 nm, preferably between 5 and 50 nm and in particular between 15 and 30 nm. They may have a spherical shape, although it is also possible to use particles which have an ellipsoidal shape or a shape which deviates in some other way from the spherical form. The pigments may also be surface-treated, i.e. hydrophilicized or hydrophobicized. Typical examples are coated titanium dioxides, for example titanium dioxide T 805 (Degussa) or Eusolex® T2000 (Merck). Suitable hydrophobic coating compositions are in particular silicones and especially trialkoxyoctylsilanes or simethicones. Preference is given to using micronized zinc oxide.

UV absorbers may be present in the inventive products in amounts of up to 5% by weight, preferably up to 3% by weight, more preferably from 0.01 to 2.0% by weight and in particular from 0.03 to 1% by weight.

A further class of stabilizers to be used with preference is that of the fluorescent dyes. They include the 4,4′-diamino-2,2′-stilbenedisulfonic acids (flavone acids), 4,4′-distyrylbiphenyls, methylumbel-liferones, coumarins, dihydroquinolinones, 1,3-diaryl-pyrazolines, naphthalimides, benzoxazole, benzisooxazole and benzimidazole systems, and pyrene derivatives substituted by heterocycles. Of particular significance in this connection are the sulfonic acid salts of diaminostilbene derivatives, and polymeric fluorescent substances, as disclosed in U.S. Pat. No. 5,082,578.

Fluorescent substances may be present in the inventive products in amounts of up to 5% by weight, preferably up to 1% by weight, more preferably from 0.01 to 0.5% by weight and in particular from 0.03 to 0.1% by weight.

In a preferred embodiment, the aforementioned stabilizers are used in any desired mixtures. The stabilizers are used in amounts of up to 40% by weight, preferably up to 30% by weight, more preferably from 0.01 to 20% by weight, in particular from 0.02 to 5% by weight.

### EXAMPLES

### Example 1

In a jacketed beaker, Isomalt® ST-F (150 g, commercial product from Palatinit) was melted with continuous stirring at 150° C. After a homogeneous mass has formed, dye(s) (optional) and zinc acetate dihydrate (17.4 g) are incorporated with stirring into the melt. The active substance-containing melt was cast in casting molds or depression tablets. After cooling, an opaque core was formed; an opaque, colored core was formed when a dye had been added.

### Example 2

In a jacketed beaker, Isomalt® ST-F (150 g) was melted with continuous stirring at 150° C. After a homogeneous mass has formed, dye(s) (optional) and manganese sulfate (3.6 g) are incorporated with stirring into the melt. The active substance-containing melt was cast in casting molds or depression tablets. After cooling, an opaque core was formed; an opaque, colored core was formed when a dye had been added.

### Example 3

Casting molds (or depression tablets) were filled with particulate zinc acetate dihydrate (250 mg) and/or particulate manganese sulfate (100 mg). In a jacketed beaker, Isomalt® ST-F was melted with continuous stirring at 150° C. and in each case 2.2 g of the homogeneous melt were poured into the casting molds. After solidification, the moldings had a transparent high-gloss appearance. The salts used (zinc acetate dihydrate and/or manganese sulfate) were visible in the molding.

### Example 4

Various manganese sulfate-containing machine dishwasher detergents were tested for their silver corrosion protection properties. To this end, silver cutlery was washed in a continuously operated dishwasher with differently formulated machine dishwasher detergents at a water hardness of 0-1° GH. All products contained 100 mg of manganese sulfate, and this manganese sulfate was present as a constituent of a compressed tablet phase (C1), as a constituent of a compressed core (C2) or as a constituent of an inventive active phase (I1). The rinse procedure was repeated 100 times under the above-described conditions. The overall appearance of the ware was assessed with reference to the assessment scale detailed below. The results are reported in the following table (assessment scale: 0=no corrosion to 4=high corrosion):

| | Silver mark |
|---|---|
| C1 | 1.9 |
| C2 | 2.4 |
| I1 | 1.5 |

The table shows that the inventive machine dishwasher detergent having an active phase has distinctly better silver corrosion properties under the conditions specified. The incorporation of the manganese sulfate in the active phase improves the silver corrosion protection.

As used herein, the articles “a” and “an” are synonymous and used interchangeably with at least one “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

1. A single- or multiphase detergent tablet that has at least one active phase that comprises one or more washing or cleaning substance(s) and a solid matrix enclosing the substance(s) in the form of a solidified melt, wherein the matrix material is selected from the group consisting of sugars, sugar acids, sugar alcohols, and any mixtures thereof, and wherein the solid matrix has a solubility above 100 g/l at 20° C. and the proportion by weight of the solid matrix in the total weight of the active phase is at least 10% by weight.

2. The detergent tablet of claim 1, wherein the solid matrix has a solubility above 200 g/l at 20° C.

3. The detergent tablet of claim 2, wherein the solid matrix has a solubility above 300 g/l at 20° C.

4. The detergent tablet of claim 1, wherein the proportion by weight of the solid matrix in the total weight of the active phase is at least 20% by weight.

5. The detergent tablet of claim 4, wherein the proportion by weight of the solid matrix in the total weight of the active phase is at least 40% by weight.

6. The detergent tablet of claim 5, wherein the proportion by weight of the solid matrix in the total weight of the active phase is at least 80% by weight.

7. The detergent tablet of claim 6, wherein the proportion by weight of the solid matrix in the total weight of the active phase is at least 90% by weight.

8. The detergent tablet of claim 1, wherein the active phase comprises:
a) from 10 to 98% by weight of matrix material,
b) from 1.5 to 90% by weight of one or more washing and/or cleaning substance(s) and
c) from 0 to 1.0% of a dye.

9. The detergent tablet of claim 1, wherein the matrix material comprises one or more meltable substances that have a melting point between 30 and 250° C.

10. The detergent tablet of claim 9, wherein the matrix material comprises one or more meltable substances that have a melting point between 35 and 200° C.

11. The detergent tablet of claim 10, wherein the matrix material comprises one or more meltable substances that have a melting point between 40 and 180° C.

12. The detergent tablet of claim 1, wherein the matrix comprises a material selected from the group consisting of oligosaccharides, oligosaccharide derivatives, monosaccharides, disaccharides, monosaccharide derivatives, disaccharide derivatives, and mixtures thereof.

13. The detergent tablet of claim 12, wherein the matrix comprises a material selected from the group consisting of glucose, fructose, ribose, maltose, lactose, sucrose, maltodextrin, Isomalt®, and any mixtures thereof.

14. The detergent tablet of claim 1, wherein the washing or cleaning substances enclosed by the solid matrix are selected from the group consisting of the enzymes, glass corrosion inhibitors, silver protectants, film-inhibiting polymers, pH modifiers, or any mixture thereof.

15. The detergent tablet of claim 1, having a depression that encloses the active phase at least partly.

16. The detergent tablet of claim 1, comprising the active phase in the form of a layer.

17. The detergent tablet of claim 1, having a planar outer surface partly covered by the active phase, to which planar outer surface the active phase adheres.

18. The detergent tablet of claim 1, wherein the washing or cleaning substances are present in the matrix that encloses them in a preformulated form selected from the group consisting of crystals, powder, granules, extrudates, compactates, castings, or any combination thereof.

19. The detergent tablet of claim 1, having a fracture hardness below 30 N.

20. The detergent tablet of claim 19, having a fracture hardness below 25 N.

21. The detergent tablet of claim 20, having a fracture hardness below 20 N.

22. The detergent tablet of claim 1, having a fracture hardness below 100 N.

23. The detergent tablet of claim 22, having a fracture hardness below 85 N.

24. The detergent tablet of claim 23, having a fracture hardness below 70 N.

25. The detergent tablet of claim 1, wherein the proportion by weight of the active phase is at least 5% by weight of the total weight of the detergent tablet.

26. The detergent tablet of claim 25, wherein the proportion by weight of the active phase is at least 7.5% by weight of the total weight of the detergent tablet.

27. The detergent tablet of claim 26, wherein the proportion by weight of the active phase is at least 10% by weight of the total weight of the detergent tablet.

28. The detergent tablet of claim 1, wherein the phase comprising one or more washing or cleaning substances enclosed by a solid matrix makes up at least 5% of the total surface area of the detergent tablet.

29. The detergent tablet of claim 28, wherein the phase comprising one or more washing or cleaning substances enclosed by a solid matrix makes up at least 7.5% of the total surface area of the detergent tablet.

30. The detergent tablet of claim 29, wherein the phase comprising one or more washing or cleaning substances enclosed by a solid matrix makes up at least 10% of the total surface area of the detergent tablet.

31. The detergent tablet of claim 1, having a quotient of the proportion by weight of the active phase in the total weight of the detergent tablet and the proportion of the active phase in the total surface area of the detergent tablet of at least 0.1.

32. The detergent tablet of claim 31, having a quotient of the proportion by weight of the active phase in the total weight of the detergent tablet and the proportion of the active phase in the total surface area of the detergent tablet of at least 0.2.

33. The detergent tablet of claim 32, having a quotient of the proportion by weight of the active phase in the total weight of the detergent tablet and the proportion of the active phase in the total surface area of the detergent tablet of at least 0.4.

34. The detergent tablet of claim 33, having a quotient of the proportion by weight of the active phase in the total weight of the detergent tablet and the proportion of the active phase in the total surface area of the detergent tablet of at least 1.0.

35. The detergent tablet of claim 1, wherein the tablet has a water-soluble casing.
